(19) United States
(12) Patent Application Publication
(10) Pub. No.: US 2007/0118416 A1
(43) Pub. Date: May 24, 2007

(54) Method and system for planning

(75) Inventor: Alanna Hendren, Surrey (CA)

Correspondence Address: PERKINS COIE LLP;PATENT-SEA, P.O. BOX 1247, SEATTLE, WA, 98111-1247, US

(73) Assignee: Developmental Disabilities Association of Vancouver-Richmond, Richmond (CA)

(21) Appl. No.: 11/282,192

(22) Filed: Nov. 18, 2005

(51) Int. Cl. G05B 19/418

(52) U.S. Cl. 705/8

(57) ABSTRACT

The present invention relates to a way of planning an action, namely deciding whether the action is generic or unique and then planning the action according to a first procedure if the action is generic or alternatively planning the action according to a second procedure if the action is unique. The first procedure includes budgeting resources in accordance with geo-historical data and index adjustment. The second procedure includes dividing the action into a list of tasks and then for each task: determining a set of resource requirements for completing the task; specifying each resource requirement; for each specified resource requirement, identifying at least one satisfactory available resource; and respectively matching one identified resource to each specified resource requirement. The second procedure is particularly well adapted for balancing other factors in addition to financial cost and for allocating accountability very precisely.

### BACKGROUND OF THE INVENTION

1. Field of the Invention

The present invention relates to ways of planning. More particularly it relates to ways of planning to meet the needs of people living within a community, for example, people working to overcome developmental disabilities.

2. Description of Related Art

The business, academic and government literature does not lack for methods and systems of planning. Planning methods and systems are even well represented in the patent literature.

It may therefore be surprising that public and private sector stakeholders have sometimes faced significant difficulty in effectively planning to meet the needs of clients within a community setting, as opposed to a rigidly controlled institutional setting. This challenge is particularly keen in view of the widespread trend to deinstitutionalize people with special needs and to integrate them and support them within their communities.

A fundamental premise of many conventional community-focused planning systems, possibly a carryover from an institutional mindset, is that allocated resources be denominated in currency: a consultation with a doctor costs $175; a visit from a nurse costs $45; each client in classification A7G+ has a maximum resource allocation of $750 per month.

In practice, it has been difficult to build rigorous, objective, verifiable models for planning client-support. Perhaps because each client is very much an individual when not constrained within an artificial, institutional setting. Perhaps because community-based resources often aren't most meaningfully denominated in currency.

Some clients have tended to receive far too many resources, some of which could have been better devoted to others. Other clients have received too few resources or the wrong resources. In the result, many clients don't obtain the support that they require, resources are wasted, and stakeholders become disheartened or even cynical about the whole endeavor.

Accordingly, what is needed is a better way to plan for the needs of clients within a community setting.

### SUMMARY OF THE INVENTION

The present invention is directed to this need.

According to one aspect of the present invention, there is provided a method of planning an action, comprising: deciding whether the action is generic or unique and either planning the action according to a first procedure if the action is generic or planning the action according to a second procedure if the action is unique.

The first procedure might include budgeting resources in accordance with historical data or geo-historical data or adjusting the budget in accordance with an index.

The second procedure might include dividing the action into a list of tasks and for each task: determining a set of resource requirements for completing the task; specifying each resource requirement; for each specified resource requirement, identifying at least one satisfactory available resource; and respectively matching one identified resource to each specified resource requirement.

In this regard, identifying might include identifying at least one of an available market resource and an available non-market resource. Matching might include emphasizing to a supplier of a non-market resource the importance of that resource to the success of the plan, matching a resource requirement with the cheapest available resource identified to satisfy it, matching a resource requirement with the best available resource identified to satisfy it, matching a resource requirement with the identified available resource that is the best match, or matching a resource requirement with the identified available resource that best matches an objective of the task. Furthermore, specifying might include specifying a property other than cost, specifying cost, specifying whether a resource requirement is a requirement for a service or a requirement for a product, specifying at least one of quantity and character, where specifying quantity for a requirement for a service might include specifying at least one of frequency and duration.

The method might further include, for each task estimating the total cost of the product resources and estimating the total cost of the service resources, and furthermore estimating the cost of the action as the total cost of the tasks.

The method might further include determining whether the tasks and the resources are sufficient to complete the action according to guidelines and if determined insufficient producing a new list of tasks and a new match of resources.

The method might further include: defining a set of goals; setting measurable objectives for each goal; scheduling actions to achieve each objective; and budgeting resources for each action.

The method might further include investigating initial facts relevant to the planning and analyzing the initial facts.

The method might further include comparing the actual results of the planning against planned results, including at least one of the goals; the objectives; the actions; and the resource requirements and explaining deviations between the actual results and the planned results, and aggregating at least some of such actual results, planned results, deviations and explanations with those for similar other plans.

The method might further include determining whether the actual results are a complete success, a complete failure, or neither and, if neither, repeating the method.

According to another aspect of the present invention, there is provided a system for planning an action, having means for deciding whether the action is generic or unique, first means for planning the action according to a first procedure if the action is generic, and second means for planning the action according to a second procedure if the action is unique.

The first planning means might include means for budgeting resources in accordance with historical data or geo-historical data and means for adjusting the budget in accordance with an index.

The second planning means might include means for dividing the action into a list of tasks, means for determining a set of resource requirements for completing each task, means for specifying each resource requirement, means for identifying at least one satisfactory available resource, for each specified resource requirement and means for respectively matching one identified resource to each specified resource requirement.

The identifying means might be adapted to identify at least one of an available market resource and an available non-market resource. The matching means might include means for emphasizing to a supplier of a non-market resource the importance of that resource to the success of the plan or might be adapted to match a resource requirement with the cheapest available resource identified to satisfy it, to match a resource requirement with the best available resource identified to satisfy it, to match a resource requirement with the identified available resource that is the best match, or to match a resource requirement with the identified available resource that best matches an objective of the task. The specifying means might be adapted to specify a property other than cost, to specify cost to specify whether a resource requirement is a requirement for a service or a requirement for a product, to specify at least one of quantity and character, wherein specifying quantity for a requirement for a service includes specifying at least one of frequency and duration.

The system might further include means for estimating for each task the total cost of the product resources and the total cost of the service resources and for estimating the cost of the action as the total cost of the tasks.

The system might further include means for determining whether the tasks and the resources are sufficient to complete the action according to guidelines, such that if insufficient, the determining means directs the dividing means to divide the action into a new list of tasks, the determining means to determine a new set of resource requirements for completing each new task, the specifying means to specify each new resource requirement and the matching means to match one identified resource to each newly specified resource requirement.

The system might further include means for defining a set of goals, means for setting measurable objectives for each goal, means for scheduling actions to achieve each objective and second means for budgeting resources for each action.

The system might include means for investigating initial facts relevant to the planning and means for analyzing the initial facts.

The system might include means for comparing the actual results of the planning against planned results, including at least one of the goals, the objectives, the actions and the resource requirements and means for explaining deviations between the actual results and the planned results and means for aggregating at least some of such actual results, planned results, deviations and explanations with those for similar other plans.

The system might include means for indicating whether the actual results compared against the planned results are one of a complete success, a complete failure, and neither and means for stopping the system in response to an indication that the actual results are one of a complete success and a complete failure.

According to another aspect of the present invention, there is provided a computer-readable medium having computer-executable instructions for performing a method of planning an action, comprising: deciding whether the action is generic or unique and either planning the action according to a first procedure if the action is generic or planning the action according to a second procedure if the action is unique.

The first procedure might include budgeting resources in accordance with historical data or geo-historical data or adjusting the budget in accordance with an index.

The second procedure might include dividing the action into a list of tasks and for each task: determining a set of resource requirements for completing the task; specifying each resource requirement; for each specified resource requirement, identifying at least one satisfactory available resource; and respectively matching one identified resource to each specified resource requirement.

In this regard, identifying might include identifying at least one of an available market resource and an available non-market resource. Matching might include emphasizing to a supplier of a non-market resource the importance of that resource to the success of the plan, matching a resource requirement with the cheapest available resource identified to satisfy it, matching a resource requirement with the best available resource identified to satisfy it, matching a resource requirement with the identified available resource that is the best match, or matching a resource requirement with the identified available resource that best matches an objective of the task. Furthermore, specifying might include specifying a property other than cost, specifying cost, specifying whether a resource requirement is a requirement for a service or a requirement for a product, specifying at least one of quantity and character, where specifying quantity for a requirement for a service might include specifying at least one of frequency and duration.

The computer-readable medium might include computer-executable instructions for, for each task estimating the total cost of the product resources and estimating the total cost of the service resources, and furthermore estimating the cost of the action as the total cost of the tasks.

The computer-readable medium might include computer-executable instructions for determining whether the tasks and the resources are sufficient to complete the action according to guidelines and if determined insufficient producing a new list of tasks and a new match of resources.

The computer-readable medium might include computer-executable instructions for: defining a set of goals; setting measurable objectives for each goal; scheduling actions to achieve each objective; and budgeting resources for each action.

The computer-readable medium might include computer-executable instructions for investigating initial facts relevant to the planning and analyzing the initial facts.

The computer-readable medium might include computer-executable instructions for comparing the actual results of the planning against planned results, including at least one of the goals; the objectives; the actions; and the resource requirements and explaining deviations between the actual results and the planned results, and aggregating at least some of such actual results, planned results, deviations and explanations with those for similar other plans.

The computer-readable medium might include computer-executable instructions for determining whether the actual results are a complete success, a complete failure, or neither and, if neither, repeating the method.

According to another aspect of the present invention, there is provided a method of planning, comprising providing historical data for budgeting resources for an action that has been determined to be generic as opposed to unique. The method might include providing geo-historical data or providing an index.

According to another aspect of the present invention, there is provided a system for planning, comprising means for providing historical data for budgeting resources for an action that has been determined to be generic as opposed to unique. The means for providing historical data might include means for providing geo-historical data. The system might further include means for providing an index.

According to another aspect of the present invention, there is provided a computer-readable medium having computer-executable instructions for performing a method of planning, comprising providing historical data for budgeting resources for an action that has been determined to be generic as opposed to unique. The computer-readable medium might include computer-executable instructions for providing geo-historical data or providing an index.

According to another aspect of the present invention, there is provided a method of planning, comprising determining a set of resource requirements for completing a task in the performance of an action that has been decided to be unique as opposed to generic.

The method might include specifying each resource requirement. In this regard, specifying might include specifying a property other than cost, specifying cost, specifying whether a resource requirement is a requirement for a service or a requirement for a product, specifying at least one of quantity and character, where specifying quantity for a requirement for a service might include specifying at least one of frequency and duration.

The method might further include identifying at least one satisfactory available resource for each specified resource requirement and matching one identified resource to each specified resource requirement.

The method might further include: defining a set of goals; setting measurable objectives for each goal; scheduling actions to achieve each objective; and budgeting resources for each action.

The method might further include investigating initial facts relevant to the planning and analyzing the initial facts.

The method might further include comparing the actual results of the planning against planned results, including at least one of the goals; the objectives; the actions; and the resource requirements and explaining deviations between the actual results and the planned results, and aggregating at least some of such actual results, planned results, deviations and explanations with those for similar other plans.

The method might further include determining whether the actual results are a complete success, a complete failure, or neither and, if neither, repeating the method.

According to another aspect of the present invention, there is provided a system for planning, comprising means for determining a set of resource requirements for completing a task in the performance of an action that has been decided to be unique as opposed to generic.

The system might include means for specifying each resource requirement. In this regard, specifying might include specifying a property other than cost, specifying cost, specifying whether a resource requirement is a requirement for a service or a requirement for a product, specifying at least one of quantity and character, where specifying quantity for a requirement for a service might include specifying at least one of frequency and duration.

The system might further include means for identifying at least one satisfactory available resource for each specified resource requirement and means for respectively matching one identified resource to each specified resource requirement.

The system might further include means for defining a set of goals, means for setting measurable objectives for each goal, means for scheduling actions to achieve each objective, and means for budgeting resources for each action.

The system might further include means for investigating initial facts relevant to the planning and means for analyzing the initial facts.

The system might further include means for comparing the actual results of the planning against planned results, including at least one of the goals, the objectives, the actions and the resource requirements and means for explaining deviations between the actual results and the planned results, and means for aggregating at least some of such actual results, planned results, deviations and explanations with those for similar other plans.

The system might further include means for indicating whether the actual results compared against the planned results are one of: a complete success, a complete failure, and (iii) neither and, means for stopping the system in response to an indication that the actual results are one of a complete success and a complete failure.

According to another aspect of the present invention, there is provided a computer-readable medium having computer-executable instructions for performing a method of planning, comprising determining a set of resource requirements for completing a task in the performance of an action that has been decided to be unique as opposed to generic.

The computer-readable medium might include computer-executable instructions for specifying each resource requirement. In this regard, specifying might include specifying a property other than cost, specifying cost, specifying whether a resource requirement is a requirement for a service or a requirement for a product, specifying at least one of quantity and character, where specifying quantity for a requirement for a service might include specifying at least one of frequency and duration.

The computer-readable medium might include computer-executable instructions for identifying at least one satisfactory available resource for each specified resource requirement and for respectively matching one identified resource to each specified resource requirement.

The computer-readable medium might include computer-executable instructions for defining a set of goals, for setting measurable objectives for each goal, scheduling actions to achieve each objective, and budgeting resources for each action.

The computer-readable medium might include computer-executable instructions for investigating initial facts relevant to the planning and analyzing the facts.

The computer-readable medium might include computer-executable instructions for comparing the actual results of the planning against planned results, including at least one of: the goals; the objectives; the actions and the resource requirements and for explaining deviations between the actual results and the planned results, and aggregating at least some of such actual results, planned results, deviations and explanations with those for similar other plans.

The computer-readable medium might include computer-executable instructions for determining whether the actual results are a complete success, a complete failure, or neither and if neither, repeating the method.

According to another aspect of the present invention, there is provided a method of planning, comprising providing guidelines for determining a set of resource requirements for completing a task in the performance of an action that has been decided to be unique as opposed to generic.

The method might include providing guidelines for specifying a resource requirement. In this regard, specifying might include specifying a property other than cost, specifying cost, specifying whether a resource requirement is a requirement for a service or a requirement for a product, specifying at least one of quantity and character, where specifying quantity for a requirement for a service might include specifying at least one of frequency and duration.

The method might include providing guidelines for defining a set of goals, providing guidelines for setting measurable objectives for at least one of the goals, providing guidelines for scheduling actions to achieve at least one of the objectives, or providing guidelines for budgeting resources for at least one of the actions.

The method might include providing guidelines for investigating initial facts relevant to the planning and analyzing the facts.

The method might include providing guidelines for comparing the actual results of the planning against planned results, including at least one of: the goals; the objectives; the actions and the resource requirements and providing guidelines for explaining deviations between the actual results and the planned results, and aggregating at least some of such actual results, planned results, deviations and explanations with those for similar other plans.

The method might include providing guidelines for determining whether the actual results are a complete success, a complete failure, or neither; and if neither, repeating the method.

According to another aspect of the present invention, there is provided a system for planning, comprising means for providing guidelines for determining a set of resource requirements for completing a task in the performance of an action that has been decided to be unique as opposed to generic.

The system might include means for providing guidelines for specifying at least one of the resource requirements. In this regard, specifying might include specifying a property other than cost, specifying cost, specifying whether a resource requirement is a requirement for a service or a requirement for a product, specifying at least one of quantity and character, where specifying quantity for a requirement for a service might include specifying at least one of frequency and duration.

The system might include means for providing guidelines for defining a set of goals, means for providing guidelines for setting measurable objectives for at least one of the goals, means for providing guidelines for scheduling actions to achieve at least one of the objectives and means for providing guidelines for budgeting resources for at least one of the actions.

The system might include means for providing guidelines for investigating initial facts relevant to the planning and means for analyzing the facts.

The system might include means for providing guidelines for comparing the actual results of the planning against planned results, including at least one of: the goals, the objectives, the actions and the resource requirements and means for providing guidelines for explaining deviations between the actual results and the planned results, and means for aggregating at least some of such actual results, planned results, deviations and explanations with those for similar other plans.

The system might further include means for providing guidelines for indicating whether the actual results compared against the planned results are one of a complete success, a complete failure and neither and means for stopping the system in response to an indication that the actual results are one of a complete success and a complete failure.

According to another aspect of the present invention, there is provided a computer-readable medium having computer-executable instructions for performing a method of planning, comprising providing guidelines for determining a set of resource requirements for completing a task in the performance of an action that has been decided to be unique as opposed to generic.

The computer-readable medium might include computer-executable instructions for providing guidelines for specifying at least one of the resource requirements. In this regard, specifying might include specifying a property other than cost, specifying cost, specifying whether a resource requirement is a requirement for a service or a requirement for a product, specifying at least one of quantity and character, where specifying quantity for a requirement for a service might include specifying at least one of frequency and duration.

The computer-readable medium might include computer-executable instructions for providing guidelines for defining a set of goals, for providing guidelines for setting measurable objectives for at least one of the goals, for providing guidelines for scheduling actions to achieve at least one of the objectives and for providing guidelines for budgeting resources for at least one of the actions.

The computer-readable medium might include computer-executable instructions for providing guidelines for investigating initial facts relevant to the planning and analyzing the facts.

The computer-readable medium might include computer-executable instructions for providing guidelines for comparing the actual results of the planning against planned results, including at least one of: the goals; the objectives; the actions; and the resource requirements and for explaining deviations between the actual results and the planned results, and aggregating at least some of such actual results, planned results, deviations and explanations with those for similar other plans.

The computer-readable medium might include computer-executable instructions for providing guidelines for determining whether the actual results are a complete success, a complete failure, or neither and if neither, repeating the method.

According to another aspect of the present invention, there is provided a method of planning comprising offering an available resource for matching to resource requirements specified for tasks in the performance of actions that have been decided to be unique as opposed to generic. In this regard, offering might include offering a plurality of available resources, advertising a resource on behalf of its owner, or offering a resource on behalf of its owner.

According to another aspect of the present invention, there is provided a system for planning comprising means for offering an available resource for matching to resource requirements specified for tasks in the performance of actions that have been decided to be unique as opposed to generic. In this regard, offering might include offering a plurality of available resources, advertising a resource on behalf of its owner, or offering a resource on behalf of its owner.

According to another aspect of the present invention, there is provided a computer-readable medium having computer-executable instructions for performing a method of planning comprising offering an available resource for matching to resource requirements specified for tasks in the performance of actions that have been decided to be unique as opposed to generic. In this regard, offering might include offering a plurality of available resources, advertising a resource on behalf of its owner, or offering a resource on behalf of its owner.

According to another aspect of the present invention, there is provided a method of planning, comprising defining a set of goals to be accomplished by the execution of a set of actions, each such action planned according to a first procedure if it is generic and planned according to a second procedure if it is unique.

In this regard, the first procedure might include at least one of: budgeting resources in accordance with historical data; budgeting resources in accordance with geo-historical data; and budgeting resources in accordance with an index.

Furthermore, the second procedure might include: dividing the respective action into a list of tasks and for each task: determining a set of resource requirements for completing the task; specifying each resource requirement; for each specified resource requirement, identifying at least one satisfactory available resource and respectively matching one identified resource to each specified resource requirement.

The method might further include setting measurable objectives for each goal, scheduling actions to achieve each objective and budgeting resources for each action.

According to another aspect of the present invention, there is provided a system for planning, comprising means for defining a set of goals to be accomplished by the execution of a set of actions, each such action planned according to a first procedure if it is generic and planned according to a second procedure if it is unique.

In this regard, the first procedure might include at least one of: budgeting resources in accordance with historical data; budgeting resources in accordance with geo-historical data and budgeting resources in accordance with an index.

Furthermore, the second procedure might include: dividing the respective action into a list of tasks and for each task: determining a set of resource requirements for completing the task; specifying each resource requirement; for each specified resource requirement, identifying at least one satisfactory available resource and respectively matching one identified resource to each specified resource requirement.

The system might further include means for setting measurable objectives for each goal, means for scheduling actions to achieve each objective, and means for budgeting resources for each action.

According to another aspect of the present invention, there is provided a computer-readable medium having computer-executable instructions for performing a method of planning, comprising defining a set of goals to be accomplished by the execution of a set of actions, each such action planned according to a first procedure if it is generic and planned according to a second procedure if it is unique.

In this regard, the first procedure might include at least one of: budgeting resources in accordance with historical data; budgeting resources in accordance with geo-historical data and budgeting resources in accordance with an index.

Furthermore, the second procedure might include dividing the respective action into a list of tasks and for each task: determining a set of resource requirements for completing the task; specifying each resource requirement; for each specified resource requirement, identifying at least one satisfactory available resource and respectively matching one identified resource to each specified resource requirement.

The computer-readable medium might further include computer-executable instructions for setting measurable objectives for each goal, for scheduling actions to achieve each objective and for budgeting resources for each action.

According to another aspect of the present invention, there is provided an application program interface embodied on one or more computer readable media, comprising a first group of services related to planning an action according to first functions if the action is generic and planning the action according to a second functions if the action is unique.

In this regard, the first functions might enable budgeting resources in accordance with historical data or geo-historical data or might enable adjusting the budget in accordance with an index.

Furthermore, the second functions might enable dividing the action into a list of tasks and, for each task determining a set of resource requirements for completing the task, specifying each resource requirement, for each specified resource requirement, identifying at least one satisfactory available resource, and respectively matching one identified resource to each specified resource requirement.

According, identifying might includes identifying at least one of an available market resource and an available non-market resource. Matching might include emphasizing to a supplier of a non-market resource the importance of that resource to the success of the plan, matching a resource requirement with the cheapest available resource identified to satisfy it, matching a resource requirement with the best available resource identified to satisfy it, matching a resource requirement with the identified available resource that is the best match, or matching a resource requirement with the identified available resource that best matches an objective of the task. Specifying might include specifying a property other than cost, specifying cost, specifying whether a resource requirement is a requirement for a service or a requirement for a product, specifying at least one of quantity and character, and, in the case of specifying quantity for a requirement for a service, specifying at least one of frequency and duration.

The second functions might further enable, for each task: estimating the total cost of the product resources and estimating the total cost of the service resources.

The second functions might further enable estimating the cost of the action as the total cost of the tasks.

The second functions might further enable determining whether the tasks and the resources are sufficient to complete the action according to guidelines and if determined insufficient, reinvoking the second functions to produce a new list of tasks and a new match of resources.

The application program interface might further include a second group of services related to planning a project.

The second group of services might include first functions enabling defining a set of goals, second functions enabling setting measurable objectives for each goal, third functions enabling scheduling actions to achieve each objective, fourth functions enabling budgeting resources for each action, fifth functions enabling investigating initial facts relevant to the planning, sixth functions enabling analyzing the initial facts, seventh functions enabling comparing the actual results of the planning against planned results, including at least one of: the goals; the objectives; the actions and the resource requirements, eighth functions enabling explaining deviations between the actual results and the planned results, ninth functions enabling aggregating at least some of such actual results, planned results, deviations and explanations with those for similar other plans and tenth functions enabling determining whether the actual results are a complete success, a complete failure, or neither and, if neither, reinvoking the application program interface.

According to another aspect of the present invention, there is provided a computer system having a graphical user interface including a display and a selection device, a method of providing information about a planned action and selecting a method of planning the action, the method comprising presenting on the display a description of the planned action; presenting on the display a selectable first control associated with a computer-implemented method for planning a generic action by budgeting resources in accordance with historical data; presenting on the display a selectable second control associated with a computer-implemented method for planning a unique action by dividing the action into a list of tasks; receiving a selection signal indicative of the selection device pointing at the selected control; and in response to the selection signal, invoking the method for planning associated with the selected control.

The method might further include presenting on the display an objective of the action.

The method might further include presenting on the display guidelines for the action.

The method might further include presenting on the display actual results of the action.

According to another aspect of the present invention, there is provided a computer system having a graphical user interface including a display and a selection device, a method of estimating the cost of a planned action, the method comprising: presenting on the display a description of the planned action; presenting on the display a set of generic actions, of which one may be selected with the selection device as being the most equivalent to the planned action; and presenting on the display the historical cost of the equivalent generic action.

The method might further include presenting on the display a set of date-range filters, of which one or more may be selected with the selection device to refine the historical cost of the equivalent generic action.

The method might further include presenting on the display a set of geographic filters, of which one or more may be selected with the selection device to refine the historical cost of the equivalent generic action.

The method might further include presenting on the display a set of index adjustments, of which one or more may be selected with the selection device to refine the historical cost of the equivalent generic action.

According to another aspect of the present invention, there is provided a computer system having a graphical user interface including a display and a selection device, a method of matching an available resource to a resource requirement for a planned task, the method comprising: presenting on the display a description of the resource required; presenting on the display a specification of the resource required; and presenting on the display a set of available resources, of which one may be selected with the selection device to match the resource requirement.

The method might further include presenting on the display the specifications for each of the available resources.

The method might further include presenting on the display guidelines for matching an available resource to the resource requirement.

The method might further provide that at least one of the specification of the resource required, the specifications for each of the available resources, and the guidelines is presented in tabular format.

The method might further include presenting on the display a description of the planned task.

According to another aspect of the present invention, there is provided a computer system having a graphical user interface including a display and a selection device, a method of estimating the aggregate cost of resources matched to a planned task, the method comprising: presenting on the display a list of the matched resources, including the respective cost per time interval for each resource and presenting on the display the estimated aggregate cost as a sum of fixed plus variable costs.

The method might further include presenting the variable costs on the display as a sum of daily, weekly, monthly and yearly costs.

The method might further include presenting on the display a cost savings calculated as the difference between the aggregate of the market values of each of the matched resources and the aggregate actual cost of the matched resources.

The method might further include: selecting one of the listed matched resources with the selection device; presenting on the display a selectable control associated with a computer-implemented method for rematching available resources to the task; receiving a selection signal indicative of the selection device pointing at the selectable control; and in response to the selection signal, invoking the method for rematching available resources to the task to replace the selected resource.

According to another aspect of the present invention, there is provided a computer-readable medium having stored thereon a data structure having: a first field containing data representing a description of an action; a second field containing data designating whether the action is a generic action or a unique action; a third field containing data representing an estimated cost of the action; and if the action is designated as being a unique action, a fourth field containing data representing a list of tasks that the action has been divided into. If the action is designated as being a unique action, the data structure might further include a fifth field containing data representing lists of resource requirements respectively associated with each task or a sixth field containing data representing lists of guidelines respectively associated with at least one of: a resource requirement, a task and the action, or a seventh field containing data representing lists of available resources respectively matched with resource requirement.

According to another aspect of the present invention, there is provided premises for planning a project with a client, having: consulting facilities for consulting with the client to define goals of the project, objectives in support of the goals, and actions for achieving the objectives; research facilities for deciding whether each action is either generic or unique and for budgeting resources to each generic action in accordance with historical data; and planning facilities for planning tasks for implementing unique actions, specifying resource requirements for each task, and matching available resources to each resource requirement. In this situations, the consulting facilities and the planning facilities might be combined.

The research facilities might include access to a database of historical data.

The planning facilities might include means for communicating with stakeholders in the plan, such stakeholders possibly including the client, supporters for the client, a government entity overseeing the plan, a funding entity contributing to the funding of the plan, suppliers of available resources, and a remotely-located planner. In this regard, the means for communicating might include a meeting table, a telephone, a videophone and a computing device connected to a communication network.

The premises might include lounge facilities to enable a person to absent himself from the consulting or the planning.

The premises might reception facilities for inviting prospective clients to learn about the planning.

The premises might be sized to fit conveniently within the community being served.

Alternatively or in conjunction with the premises, planning might be conducted remotely from the premises, for example in the home of a client or some other location convenient or comfortable for the client. Such planning might be conducted with the aid of a computing device, either freestanding or connected to a network, programmed with codes encoded in a computer-readable medium to acquire, manipulate and store data pertinent to the planning process in accordance with the methods of the present invention.

Further aspects and advantages of the present invention will become apparent upon considering the following drawings, description, and claims.

### DESCRIPTION OF THE INVENTION

The invention will be more fully illustrated by the following detailed description of non-limiting specific embodiments in conjunction with the accompanying drawing figures. In the figures, similar elements and/or features may have the same reference label. Further, various elements of the same type may be distinguished by following the reference label with a second label that distinguishes among the similar elements. If only the first reference label is identified in a particular passage of the detailed description, then that passage describes any one of the similar elements having the same first reference label irrespective of the second reference label.

### 1. BRIEF DESCRIPTION OF THE DRAWINGS

FIG. 1 is a flowchart, drawn in accordance with International Standard IS05807-1985(E), of a planning method embodying aspects of the present invention;

FIG. 2 is a flowchart, drawn in accordance with International Standard IS05807-1985(E), of an embodiment of a “Budget Resources for each Action” module in the planning method of FIG. 1;

FIG. 3 is a plan view of an embodiment of a facility for conducting the planning method of FIG. 1;

FIG. 4 is a network diagram of general purpose programmable computers and communication devices connected together and programmed to carryout the method of FIG. 1;

FIG. 5 is a block diagram of a general purpose programmable computer of FIG. 4;

FIG. 6 is a block diagram of a database management system for managing the data of the method of FIG. 1, namely a Project ID database, a Facts database, a Goal database, an Objectives database, an Actions database, a Tasks database, a Resources database, a Guidelines database, a Geo-historical database, and an Aggregate Statistics database;

FIG. 7 is a pictorial diagram of a Project Select form view into the Project ID database of FIG. 6;

FIG. 8 is a pictorial diagram of a Project Profile form view into the Project ID, Facts and Goal databases of FIG. 6;

FIG. 9 is a pictorial diagram of a Goal Planner form view into the Goal and Objectives databases of FIG. 6;

FIG. 10 is a pictorial diagram of an Action Planner form view into the Objective, Action and Guideline databases of FIG. 6, in which a generic action has been selected;

FIG. 11 is a pictorial diagram of an Action Estimator form view into the Action and Geo-historical databases of FIG. 6;

FIG. 12 is a pictorial diagram of an Action Planner form view into the Objective, Action and Guideline databases of FIG. 6, in which a unique action has been selected;

FIG. 13 is a pictorial diagram of a Task Planner form view into the Action and Task databases of FIG. 6;

FIG. 14 is a pictorial diagram of a Resource Specifier form view into the Task, Resource and Guideline databases of FIG. 6;

FIG. 15 is a pictorial diagram of a Resource Budgeter form view into the Task, and Resource databases of FIG. 6;

FIG. 16 is a pictorial diagram of a Task Estimator form view into the Task and Resource databases of FIG. 6;

FIG. 17 is a pictorial diagram of Report Builder form for selective extracting information from the Client ID database, the Client Facts database, the Goal database, the Objectives database, the Actions database, the Tasks database, the Resources database, the Guidelines database, the Geo-historical database, and the Aggregate Statistics database.

### 2. DETAILED DESCRIPTION OF SPECIFIC EMBODIMENTS

(a) Overview

The invention will now be illustrated by explanation of specific, non-limiting, exemplary embodiments shown in the drawing figures and described in greater detail herein.

In general terms, the invention provides a rigorous and objectively transparent method for creating a plan to achieve goals, including budgeting the plan. While the invention is of general application, it is particularly well suited for integrating community-based resources—often non-market resources—into a plan.

(b) Planning Method

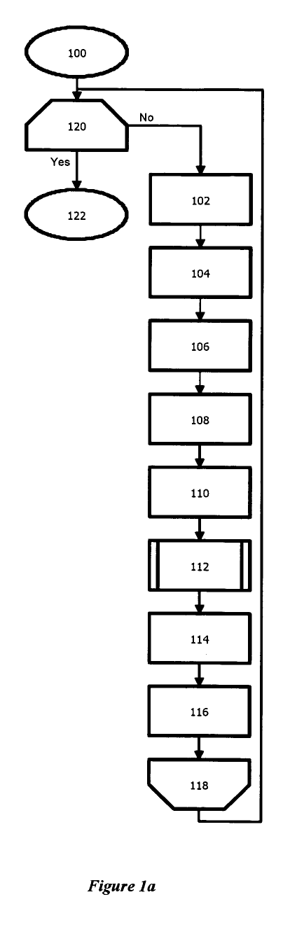

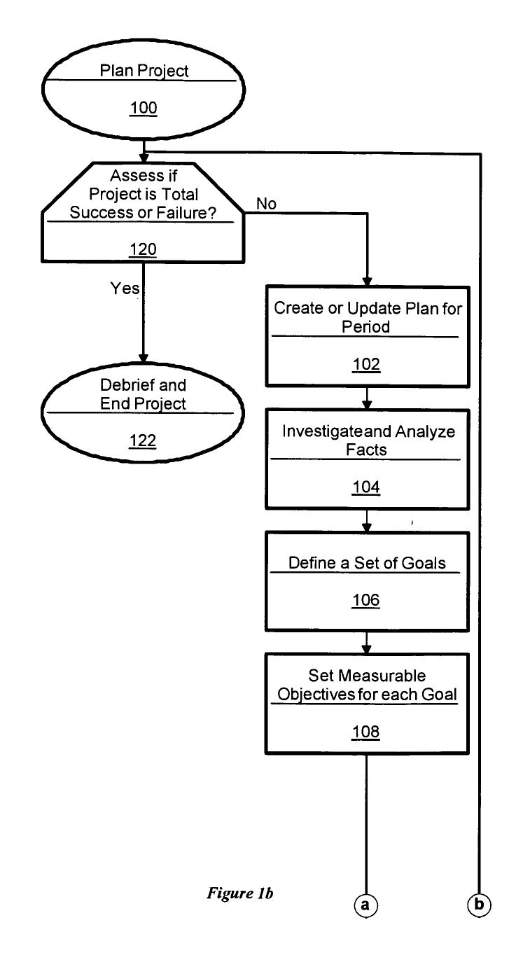

FIG. 1 shows a method for planning a project, according to one embodiment of the present invention, generally illustrated at 100.

The planning method 100 begins with a plan creation stage 102, during which the time period for the plan is established. The plan period may not be the same as the project period. Advantageously, over the span of the project period, there may be a series of plans: an initial plan and a succession of updated plans that benefit from additional information and experience gained over the course of the project.

An investigation and analysis stage 104 follows, during which the salient facts about the project are identified and considered. Such facts would include initial conditions.

A goal-defining stage 106 follows, during which goals for the project are established. Such goals would include end conditions.

An objective-setting stage 108 follows, during which measurable objectives are established for each goal.

An action-scheduling stage 110 follows, during which actions sufficient to achieve each objective are scheduled.

A resource-budgeting stage 112 follows, during which resources necessary to execute each action are identified and budgeted.

A performance-documentation stage 114 follows, during which actual performance of goals, objectives and actions and actual consumption of resources are documented.

A performance-evaluation stage 116 follows, during which actual performance/consumption is compared to planned performance/consumption and deviations are explained.

A data-aggregation stage 118 follows, during which planned and actual data and statistics are extracted and aggregated with the results of other plans to provide reference data for future plans.

Finally, a project-assessment stage 120 follows, during which the plan results are analyzed to assess whether the project itself is a total success, a total failure, or neither. If a total success or a total failure, then there follows a project-debriefing stage 122, during which lessons are sought and the planning process and the project itself are terminated. If neither a total success no a total failure, then the project is continued and the plan is updated for another period, starting with the plan creation stage 102.

(c) Budgeting Method

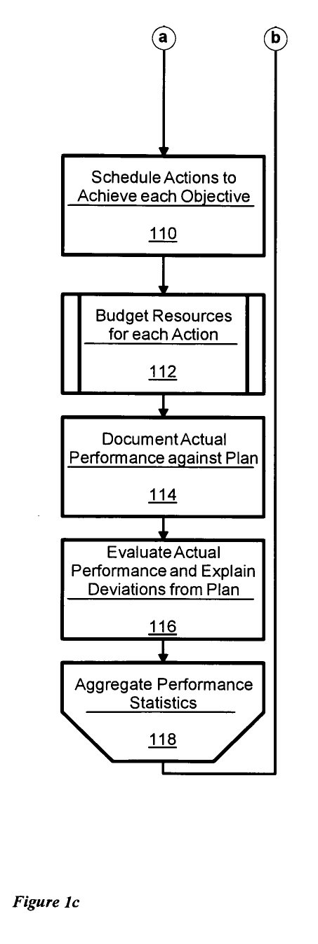

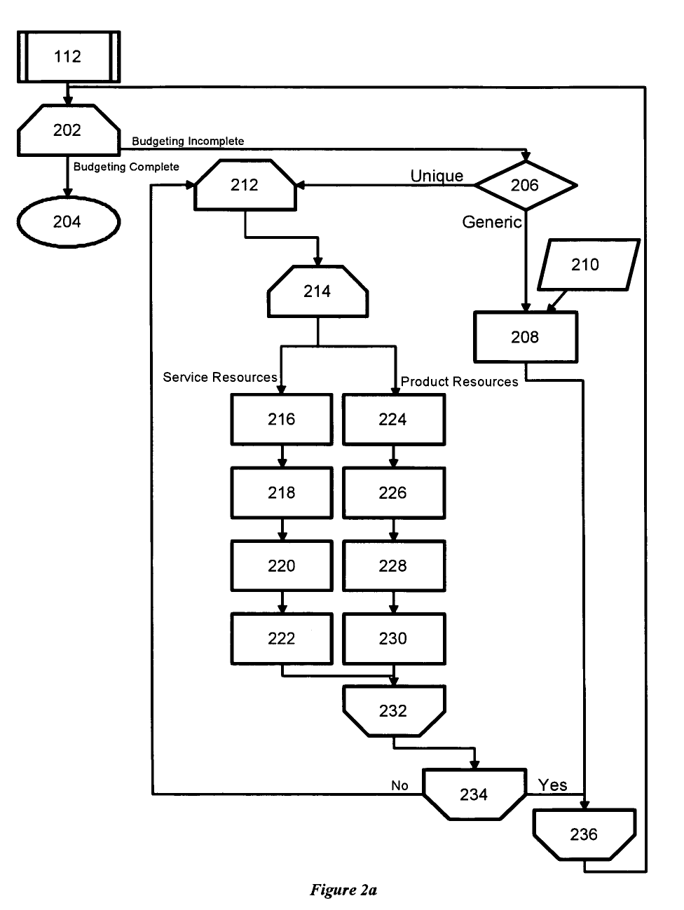

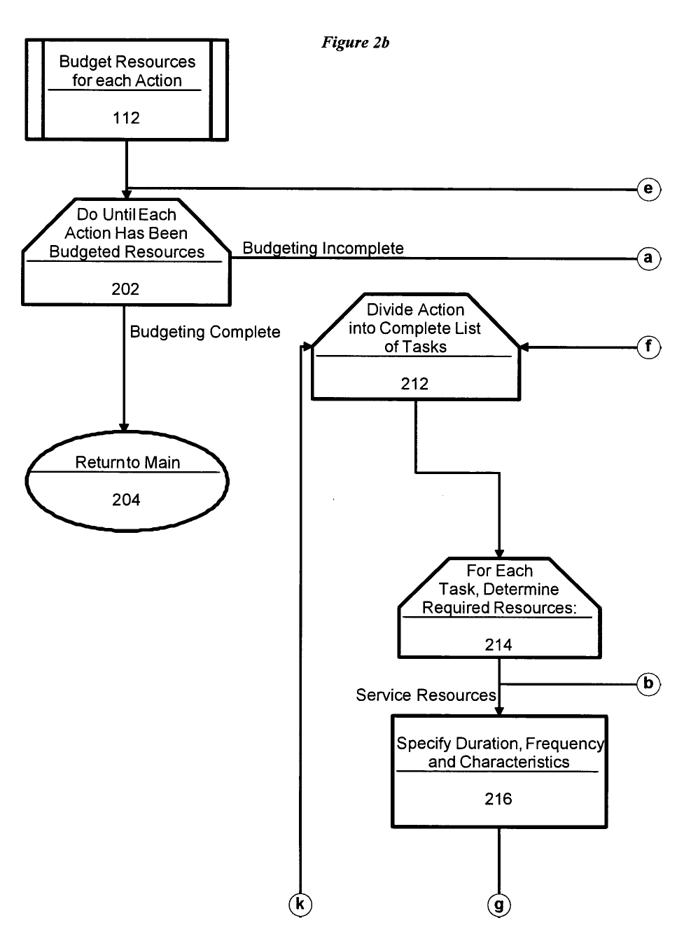

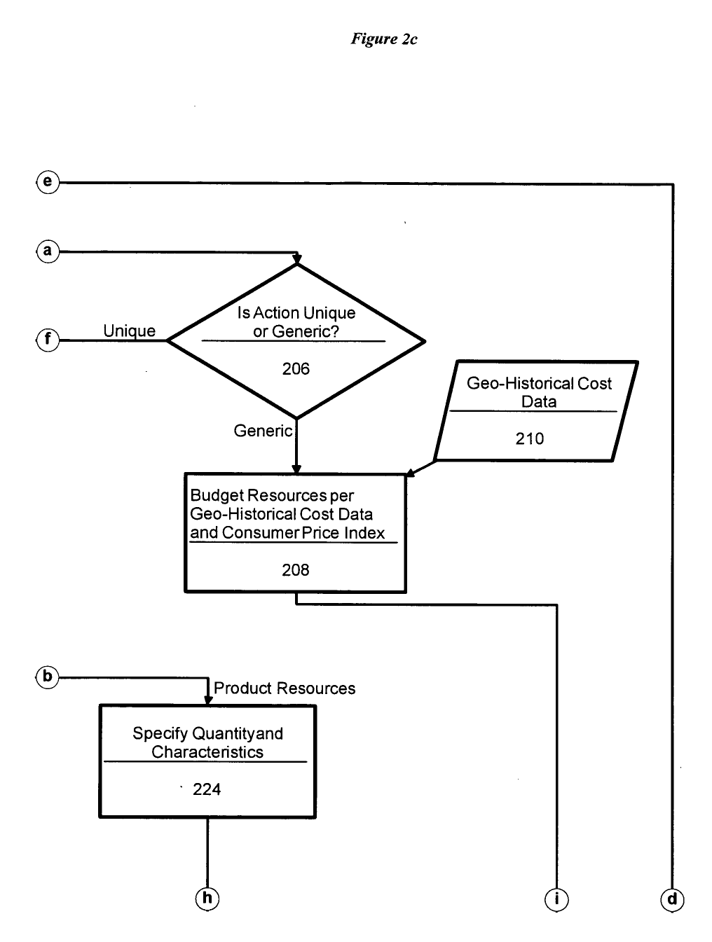

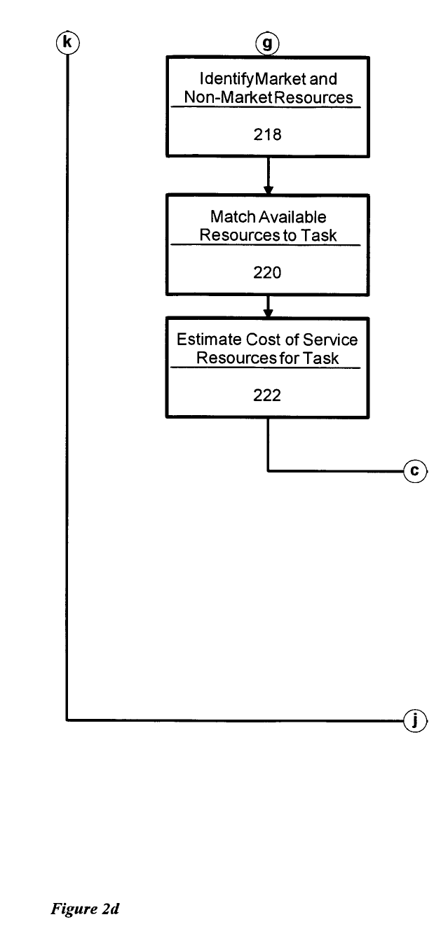

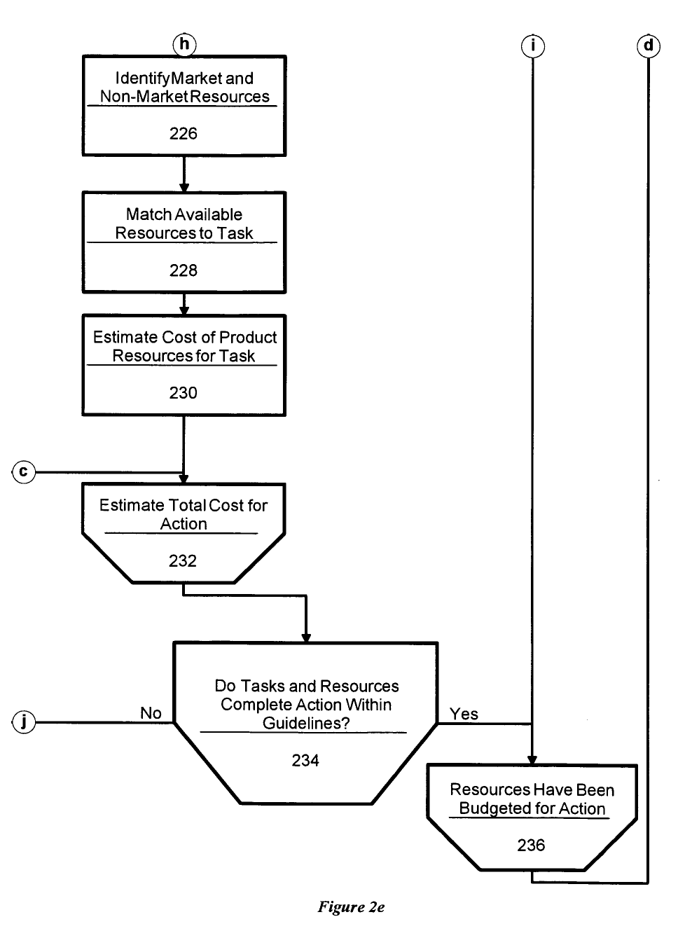

FIG. 2 illustrates in greater detail one embodiment of the resource-budgeting stage 112.

In accordance with an outer loop 202-236, all of the scheduled actions are budgeted in turn, after which the resource-budgeting stage 112 terminates 204.

At an initial sorting stage 206, it is decided whether an action is better classified as generic or unique. In this sense, a generic action is one that would reasonably fit within a class of actions for which relevant statistics are conveniently available to the planner. For example, if the action was to move into a house in a particular town, there would be geo-historical data evidencing what houses have cost in various neighborhoods at various points in time and what it costs to move ones possessions across a specific distance. A good clue that an action is generic is that it can be easily denominated in currency.

In contrast, a unique action is one for which no such data is conveniently available, possibly because the relevant population is too small or of too little interest for anyone to have tracked. For example, it is unlikely that there are statistics offering guidance about what it would cost or what other resources might be needed to teach a cat how to play mini-golf. Therefore there is no easy, top-down, statistical way to budget this action. Instead, one might adopt a more laborious, bottom-up process, deconstructing the action into recognizable tasks for which resources may be specified with more confidence.

As used herein, the word “unique” does not mean “the only one of its kind”; instead, it means “without equivalent”, in that comparable data is not available for planning, budgeting or the like. In this more relative sense, the classification of an action as being either generic or unique may very much depend on what specific data sets are available.

If the action is generic, then in a single action-budgeting stage 208 the action is matched with suitable geo-historical data 210, and possibly modified by an index such as the consumer price index, to budget resources for the action 236, after which the next action, if any, may be processed through the resource-budgeting stage 112. Although broadly based comparable data should provide some insight for budgeting, filtering such data by date-range and/or geography and adjusting such data with indices can refine it to yield more pertinent and/or accurate insight.

Alternatively, if the action is unique, then in an action-deconstruction stage 212 the action is divided into a list of tasks sufficient to complete it. As will be described further below, the action-deconstruction stage 212 is the head of a middle loop 212-234.

In accordance with an inner loop 214-232, each of the listed tasks is in turn matched with resources sufficient to complete it and resource costs are estimated. More specifically, there is a resource-requirements stage 214 at the head of the inner loop 214-232, where resource requirements sufficient to complete each task are determined and desirably classified as either products or services.

Next, there is a resource-specification stage 216, 224, where a specification is defined for each resource requirement, against which available resources will be tested. The specification would typically define quantity and other characteristics relevant to the task, typically along dimensions of quality and availability.

Next, there is a resource-identification stage 218, 226, in which available resources similar to the resource-specification are located and in effect shortlisted. These resources might be available through regular market channels, or as is often importantly the case in community situations, they may be non-market resources.

Next, there is a resource-matching stage 220, 228, in which one identified available resource is matched to each resource-specification and thus to the task. In this stage, the best match can be defined in many ways. The matched available resource might match the specification in all respects or only some. Some aspects may be weighted more important than others. It may or may not be desirable to exceed certain aspects of the specification. The matched available resource might be the cheapest, the best quality, or the one that best matches the objective that motivates the task.

There is then a task-costing stage 222, 230, in which the cost for all the resources matched with a task are estimated and totaled.

There is then an action-costing stage 232 at the tail of the inner loop 214-232, wherein the cost of the action is estimated as the sum of the costs estimated for each of its deconstructed tasks.

Finally, there is a guideline compliance stage 234 at the tail of the middle loop 212-234, to analyze whether the tasks and matched resources will complete the action in accordance with any guidelines that might have been set. If not, then the process returns to the head of the middle loop 212-234, to deconstruct the action into a new list of tasks with new resource-requirements specifications and new matched resources to better comply with such guidelines, for example budget guidelines. Alternatively, if any and all guidelines were complied with, then processing returns to the head of the outer loop 202-236 such that a new action can be budgeted or, if all actions have been budgeted, the resource-budgeting stage 112 can terminate 204.

(d) Planning Facility

The invention can be practiced in many different embodiments. Those skilled in the art will see that the method might be used with pencil and blank paper to plan simple projects, pen with forms, workbooks, and reference manuals for larger projects, and computers or computer networks with databases for still more complicated projects. As will be discussed below, computer implementations provide a number of distinct advantages.

As was mentioned above, although the invention is of general application, it is particularly well suited for planning the integration of a person with special needs into a community. In this respect, the physical facilities in which the invention is practiced can contribute to benefits provided.

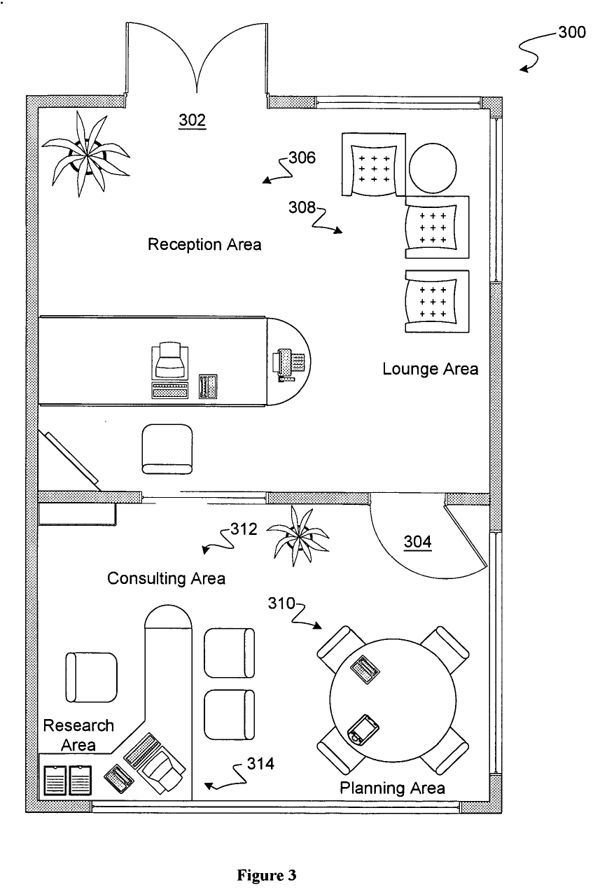

Referring now to FIG. 3, facilities for practicing the invention are generally illustrated at 300. The facilities 300 are sized to fit conveniently within the community being served, providing easy access for clients who may not have many transportation options for visiting a facility further away.

The facilities 300 are divided into a public area 302 and a private area 304. The public area 302 includes a welcoming reception area 306 and a comfortable adjacent lounge area 308. These areas invite potential clients to learn more about the facilities 300 and the planning assistance being offered.

The private area 304 includes a planning area 310, a consulting area 312 and a research area 314. The planning area 310 provides a friendly atmosphere, for example around a round table, for planners and clients to work together through a plan. Tools such as a telephone, videophone and an Internet-enabled computing device may be used to involving stakeholders remote from the facilities 300 in the planning process, for example the client himself if unable to attend in person, supporters for the client such as family or friends, representatives of government entities overseeing the plan, representatives of funding entities contributing to the funding of the plan, suppliers of available resources for the plan, and remotely-located planning personnel. The lounge area 308 is conveniently available if there is a need for some persons to absent themselves from part of the planning process.

The consulting area 312 may be useful to support a quiet and supportive conclave for investigating and analyzing pertinent facts and establishing goals, objectives and actions for the plan or may be useful if a person leading the planning process needs to apply a difference in perceived status to advance the planning process.

Finally, the research area 314, with a telephone and an Internet enabled computing device, may be useful for gathering additional information for advancing the planning process. For example, comparable historical data might be studied to estimate costs or resources for matching resource requirements might be identified at the research area 314.

(e) Computers

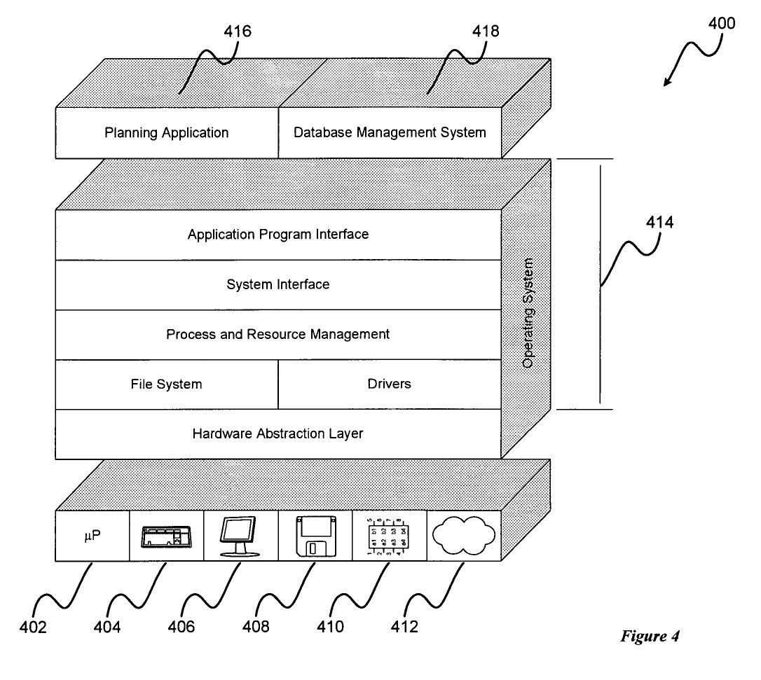

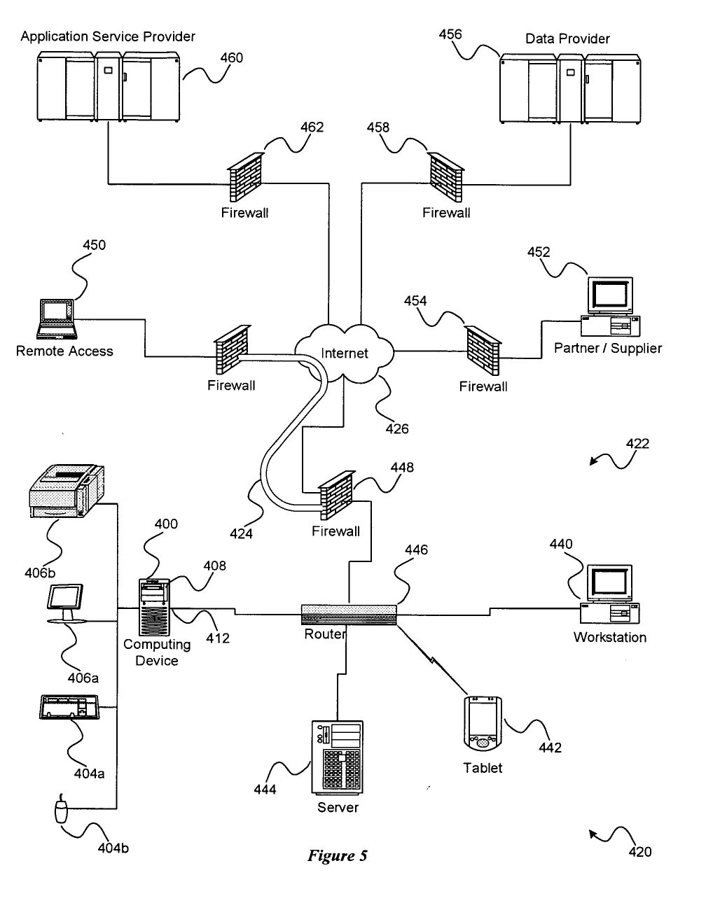

Referring now to FIGS. 4 and 5, a computing device for implementing the invention is generally illustrated at 400. The computing device 400 includes a microprocessor 402, input devices 404, including a keyboard 404a and a mouse 404b, output devices 406, including a video display 406a and a printer 406b, mass storage 408, including a hard drive and an optical drive, memory 410, including read only memory and random access memory, and a network interface 412.

Stored in a portion of the read only memory and the hard drive are the components of an operating system 414, for example including Microsoft® Windows® XP, that instructs the microprocessor 402 how to communicate and interact with the other devices described above and more generally how to perform the functions of a general purpose programmable computer, including storing, accessing and manipulating data, running software applications, and communicating with remote devices across a network in accordance with networking protocols, for example TCP/IP.

While the computing device 400 might help to implement the invention through the use of standard software, for example word-processing or spreadsheet software, perhaps with templates and prompts, for documenting the planning process, those skilled in the art will appreciate that dedicated software specifically adapted to implementing the invention will provide greater benefits. To this end, the computing device 400 would have access to planning application software 416 that embodies the planning method 100 and to a database management system 418 for storing, accessing and manipulating the data relevant to the planning method 100. As best seen in FIG. 5, the planning application software 416 and the database management system 418 can interact with the computing device 400 via the operating system 414. As will be described in greater detail below, the planning application software 416, the database management system 418, and the relevant data may in whole or in part be remote from the computing device 400 and accessible through the network interface 412 or local to the computing device 400, for example stored on the mass storage 408 device. In this regard, the planning application software 416, the database management system 418, and the relevant data may be encoded on one or more computer readable media, including solid-state memory circuits, magnetic storage media, optical storage media, and electromagnetic carrier waves or any other suitable read-only or read/write medium.

(f) Network

Although a single computing device 400 could deliver benefits in implementing the invention, those skilled in the art will appreciate that the invention lends itself particularly well to implementation over a computer network, generally illustrated at 420. The computer network 420 might include a local area network 422, a virtual private network 424, and an internetwork 426, for example the Internet.

The local area network 422 may connect the computing device 400 to a workstation 440, a wireless tablet 442, and a file server 444 through a router 446, thus for example facilitating cooperation between planners in the reception area 306, the research area 314, and the planning area 310 in the facilities 300.

The router 446 also connects the local area network 422 to the internetwork 426 through a firewall 448, thus facilitating wider collaboration in the planning process.

For example, a planner with a laptop computer 450 connected to the local area network 422 through the virtual private network 424 could assist in planning from a remote location, for example investigating resources out in the community or meeting with a client in the client's home or another location convenient or comfortable for the client.

A supplier or other partner might connect his inventory computer 452 through a firewall 454 to the local area network 422, thus making his inventory information known for the purpose of matching available resources to resource-requirements and even for the purpose of executing a transaction to obtain the matched resources. Some or all of this inventory might be the partner's own property, or else it might be the property of other entities on behalf of whom the partner provides advertisement or extends an offer for sale or other transaction.

A data-broker or government agency might allow the local area network 422 to connect to its data-server 456 through the internetwork 426 and a firewall 458 to access its collection of data, for example geo-historical data 210 and indices relevant to generic actions being planned.

And finally, an application service provider might allow the local area network 422 to connect to its application-server 460 through the internetwork 426 and a firewall 462 to access planning application software 416 should it be desirable to host the application remotely.

(g) Databases

Thus it will be seen that some or all of the planning application software 416 and some or all of the database management system 418 may reside locally on the computing device 400 or may be distributed about the computer network 420, accessed for example, via application program interfaces.

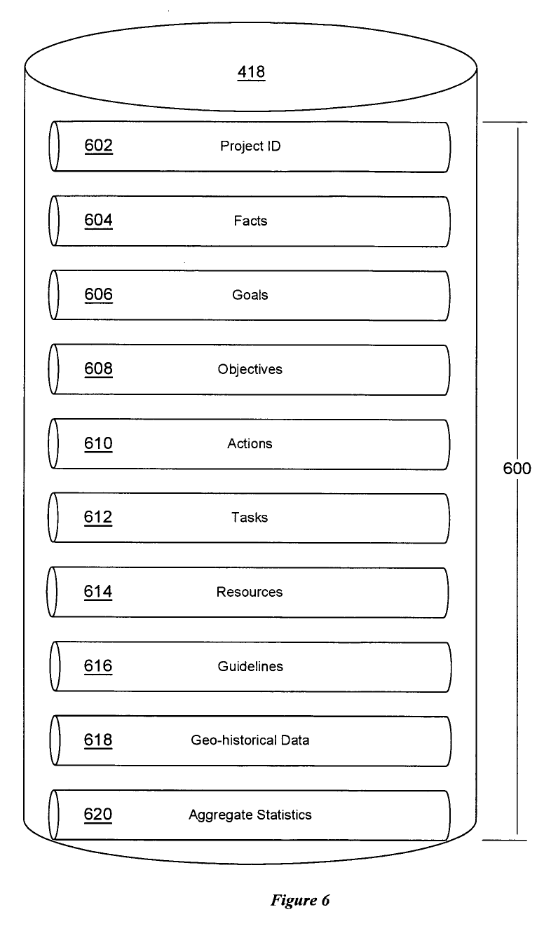

FIG. 6 illustrates the database management system 418 in greater detail. The database management system 418 controls the storage, access and manipulation of data relevant to the planning method 100. The relevant data may be stored in a set of databases 600 that may be related to each other as is well-known in the art. The databases 600 might be relational databases, object-oriented databases, or object-relational databases, for example.

According to one embodiment, the set of databases 600 would include a Project ID database 602, a Facts database 604, a Goals database 606, an Objectives database 608, an Actions database 610, a Tasks database 612, a Resources database 614, a Guidelines database 616, a Geo-historical database 618, and an Aggregate Statistics database 620, as will be described in greater detail below. The Goals database 606, the Objectives database 608, the Actions database 610, the Tasks database 612, the Resources database 614 might for example include data pertaining to their planned values and actual values, statistics defining the differences between the planned and actual values, and notes describing progress, performance, the values and the statistics.

(h) Forms

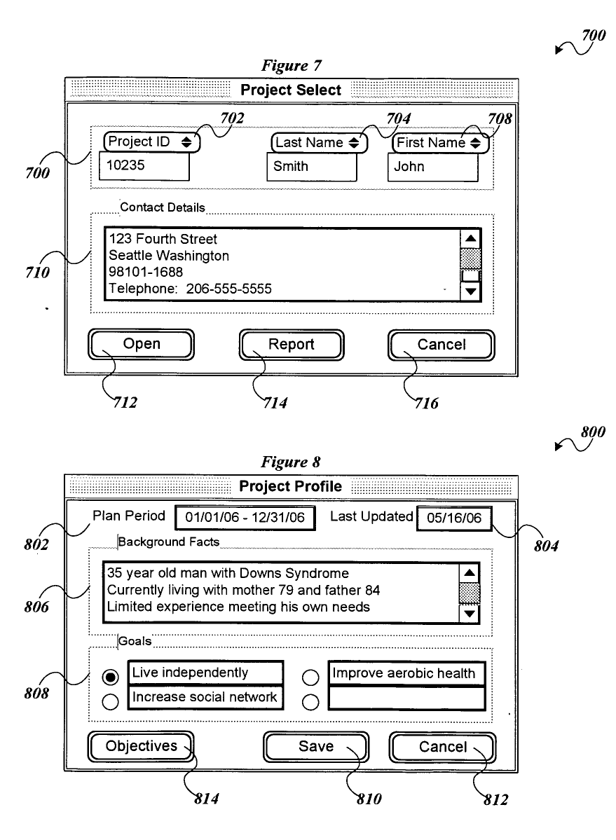

FIG. 7 shows a Project Select view, generally illustrated at 700, into the Project ID database 602. The Project Select view 700 enables a user to select a project to plan or track.

The Project Select view 700 includes a project query region 702 that includes a Project ID field 704, a contact Last Name field 706 and a contact First Name field 708. Values entered in any of these fields will cause the Project ID database 602 to be searched for an associated project. If an associated project is located, then contact details will be displayed in a contact details region 710 so that the user can confirm the located project is the one he is searching for. If no project is located, then the user can input contact details in the contact details region 710 to create a new project.

The Project Select view 700 includes a project Open button 712, a project Report button 714 and a project Cancel button 716.

The project Open button 712 opens for processing the selected project identified in the project query region 702 and the contact details region 710, whether that be an existing project that was located by search query or a brand new project. More particularly, a Project Profile view 800 is opened, as will be described in greater detail with reference to FIG. 8.

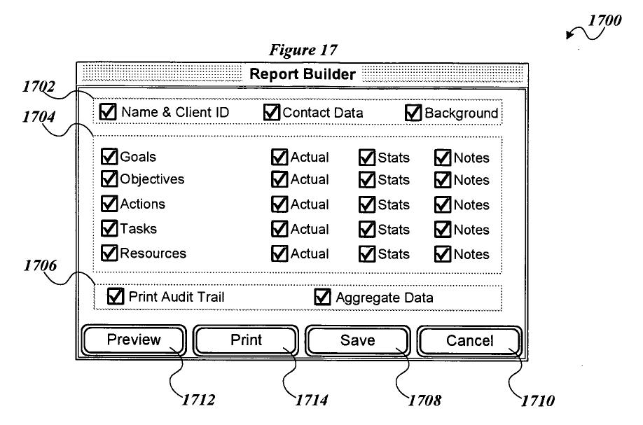

The project Report button 714 invokes a report builder for reporting on the selected project, as will be more fully described with respect to FIG. 17.

The project Cancel button 716 closes the Project Select view 700 without action.

FIG. 8 shows the Project Profile view, generally illustrated at 800, into the Project ID database 602, Facts database 604 and the Goals database 606. The Project Profile view 800 enables a user to plan a project at its highest level, identifying and analyzing facts about the project and establishing a set of goals for the project.

The Project Profile view 800 includes a plan period field 802, an update date field 804, a facts region 806 and a goals summary region 808.

The plan period field 802 documents the start date, end data and period of the plan. The update date field 804 documents the last time that a change was made to the plan for the project.

The facts region 806 documents salient facts about the project, for example in the embodiment illustrated that the project relates to a 35 year old man (named John Smith 708, 706) who has Downs Syndrome, has limited experience meeting his own needs, and currently lives with his mother 79 and father 84.

As illustrated, the facts region 806 is a simple memo field supporting freeform documentation of facts; however, the facts region 806 might also include prompts and static or dynamic templates to guide users through the investigation and analysis of the facts that are most salient to the project.

The goals summary region 808 documents to level goals for the project, for example as illustrated, that John live independently, that he increase his social network, and that he improve his aerobic health.

Revisions to the data presented in the Project Profile view 800 can be saved to the appropriate set of databases 600 through the database management system 418 by activating the project profile Save button 810. Alternatively, such revisions can be discarded by activating the project profile Cancel button 812.

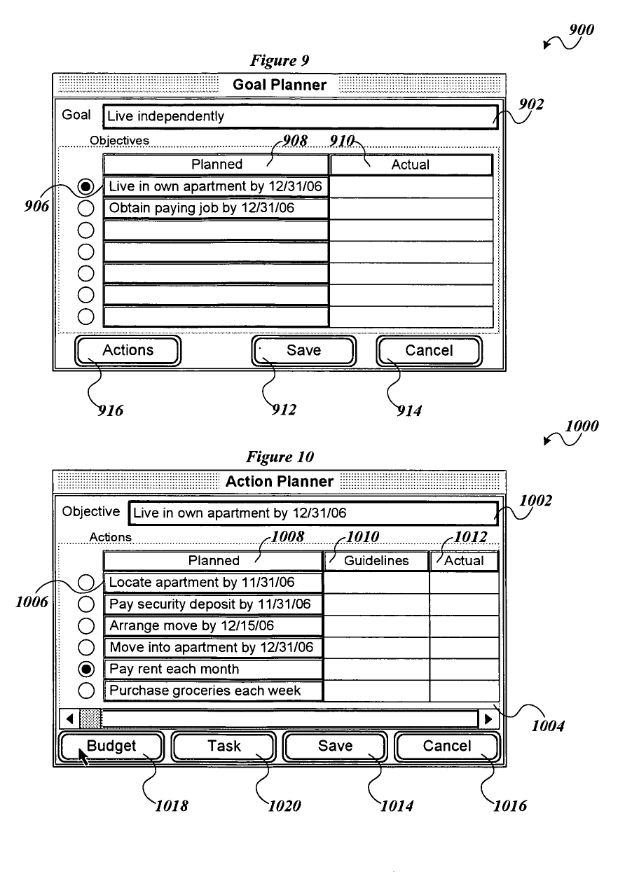

Any one of the goals documented in the goals summary region 808 may be selected for further processing upon activation of the Objectives button 814. More particularly, a Goal Planner view 900 will be opened, as is described more thoroughly with respect to FIG. 9. In the embodiment illustrated, the goal selected for further processing is for John to live independently.

FIG. 9 shows the Goal Planner view, generally illustrated at 900, into the Goals database 606 and the Objectives database 608 The Goal Planner view 900 enables a user to define measurable objectives for the selected goal.

The Goal Planner view 900 includes a goal field 902 and an objectives table 904, wherein each objective has its own objective-row 906 that intersects a planned-column 908 and an actual-column 910.

The goal field 902 identifies the currently selected goal being processed.

The objectives table 904 documents the objects by which the currently selected goal will be measured, the planned-column 908 documenting the objective as originally expressed and the actual-column 910 documenting how closely the objective was achieved. In the example embodied there are two objectives, namely that John live in his own apartment by Dec. 31, 2006 and that he obtain a paying job by Dec. 31, 2006.

As illustrated, the objectives table 904 is a simple table; however, it might also include prompts and static or dynamic templates to guide users through the definition of meaningful measurable objectives for the selected goal.

Revisions to the data presented in the Goal Planner view 900 can be saved to the appropriate set of databases 600 through the database management system 418 by activating the goal planner Save button 912. Alternatively, such revisions can be discarded by activating the goal planner Cancel button 914.

Any one of the objectives documented in the objectives table 904 may be selected for further processing upon activation of the Actions button 916. More particularly, an Action Planner view 1000 will be opened, as is described more thoroughly with respect to FIG. 10. In the embodiment illustrated, the objective selected for further processing is for John to live in his own apartment by Dec. 31, 2006.

FIG. 10 shows the Action Planner view, generally illustrated at 1000, into the Objectives database 608, the Actions database 610, and the Guidelines database 616. The Action Planner view 1000 enables a user to define schedule actions to accomplish the selected objective.

The Action Planner view 1000 includes an objective field 1002 and an actions table 1004, wherein each action has its own action-row 1006 that intersects a planned-column 1008, a guidelines-column 1010 and an actual-column 1012.

The objective field 1002 identifies the currently selected objective being processed.

The actions table 1004 documents the actions scheduled to accomplish the currently selected objective, the planned-column 1008 documenting the action as originally expressed, the guidelines-column 1010 providing advice or constraints on scheduling such actions, and the actual-column 1012 documenting how closely the action was accomplished. In the example embodied there are six actions scheduled to accomplish the objective that John live in his own apartment by Dec. 31, 2006, namely that he locate an apartment by Nov. 31, 2006, that he pay a security deposit by Nov. 31, 2006, that he arrange his move by Dec. 15, 2006, that he move into the apartment by Dec. 31, 2006, that he pay rent each month, and that he purchase groceries each week.

As illustrated, the actions table 1004 is a simple table; however, it might also include prompts and static or dynamic templates to guide users through the definition of meaningful measurable objectives for the selected goal. The guidelines in the guidelines-column 1010 might either be entered manually or extracted automatically from the guidelines database 616.

Data entered or revised in the Action Planner view 1000 can be saved to the appropriate set of databases 600 through the database management system 418 by activating a Save button 1014. Alternatively, such revisions can be discarded by activating a Cancel button 1016.

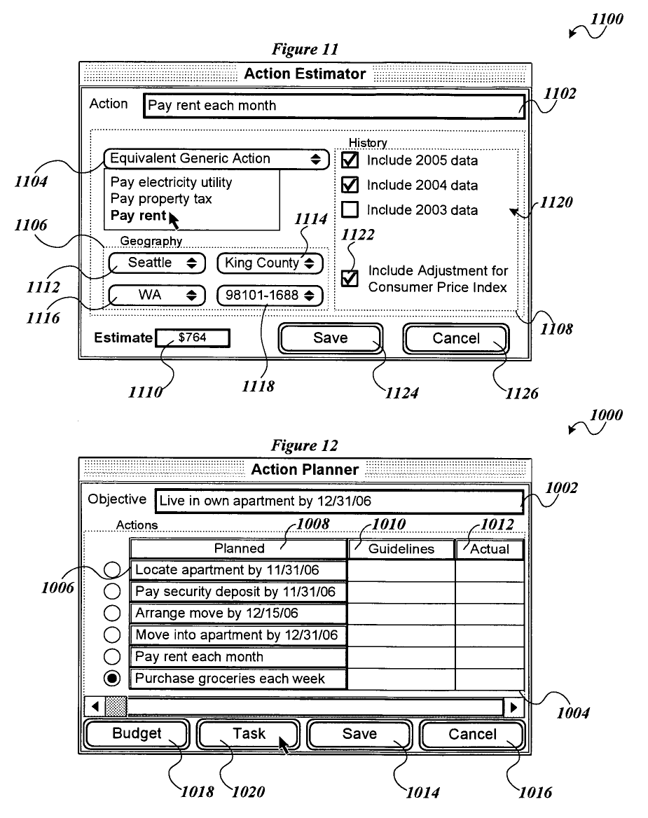

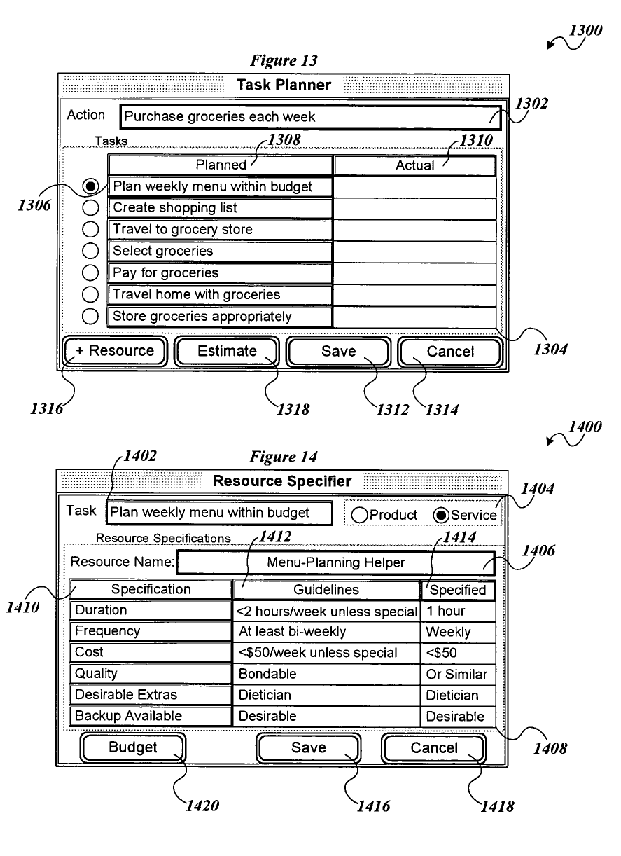

Any one of the actions documented in the actions table 1004 may be selected for further processing. Upon activation of a Budget button 1018, an Action Estimator view 1100 will be opened, as is described more thoroughly with respect to FIG. 11. Alternatively, upon activation of a Tasks button 1020, a Task Planner view 1300 will be opened, as is described more thoroughly with respect to FIG. 13. In general terms, one would activate the Budget button 1018 to directly budget a generic action but would activate the Tasks button 1020 to deconstruct a unique action into a list of tasks to be budgeted.

In the embodiment illustrated in FIG. 10, the action “Pay rent each month” has been selected and the Budget button 1018 activated.

FIG. 11 shows the Action Estimator view 1100, generally illustrated at 1100, into the Actions database 610, the Resources database 614 and the Geo-historical database 618. The Action Estimator view 1100 enables a user to quickly and simply budget resources for generic actions.

The Acton Estimator view 1100 includes an action field 1102, a generic-action selector 1104, a geographic-constraint region 1106, an historical-constraint region 1108, and an estimate field 1110.

The action field 1102 identifies the currently selected action that is being budgeted.

The generic-action selector 1104 presents a list of generic actions for which budgeting statistics are accessible. To make use of the Action Estimator view 1100 as a quick and simply way to budget resources, the user selects one of the listed generic action to match the action being budgeted. If the user determines that no suitable match exists, then the action must be budgeted through deconstruction into tasks, as will be described further below. As illustrated, the user has selected the generic action “Pay rent” to match the action “Pay rent each month”.

The geographic-constraint region 1106 presents geographic constraints for filtering the geo-historical data to extract a more relevant and accurate subset. For example, the user might set a city constraint 1112, a county constraint 1114, a state constraint 1116 or a ZIP-code constraint 1118, as illustrated, Seattle, King County, Wash., 98101-1688.

The historical-constraint region 1108 presents historical constraints for filtering the geo-historical data to extract a more relevant and accurate subset. For example, the user might set data-collection-date constraints 1120, as illustrated constraining the data to that collected for the years 2004 and 2005.

The historical-constraint region 1108 also includes an index-adjustment selector 1122 for selecting whether or not to post-process the data with an index adjustment, for example as illustrated, the Consumer Price Index.

The estimate field 1110 presents an estimated cost for the action being budgeted, based upon the geo-historical data maintained in the geo-historical database 618 as configured by the settings of the geographic-constraint region 1106, the historical-constraint region 1108, and the index-adjustment selector 1122.

Data entered or revised in the Action Estimator view 1100 can be saved to the appropriate set of databases 600 through the database management system 418 by activating a Save button 1124. Alternatively, such revisions can be discarded by activating a Cancel button 1126. In one embodiment of the invention, the saved data will include no only the estimated cost for the action, but also a list of component tasks for executing the action.

Referring now to FIG. 12, the Action Planner view 1000 is illustrated in a different state than was illustrated in FIG. 10. As illustrated in FIG. 12, the action “Purchase groceries each week” task has been selected and the Tasks button 1020 has been activated, which causes a Task Planner view 1300 to be opened.

FIG. 13 shows the Task Planner view, generally illustrated at 1300, into the Actions database 610 and the Tasks database 612. The Task Planner view 1300 enables a user to divide the selected action into a list of component tasks.

The Task Planner view 1300 includes an action field 1302 and tasks table 1304, wherein each task has its own task-row 1306 that intersects a planned-column 1308 and an actual-column 1310.

The action field 1302 identifies the currently selected action being deconstructed.

The tasks table 1304 documents a list of tasks to accomplish the currently selected action, the planned-column 1308 documenting each task as originally expressed and the actual-column 1310 documenting how closely the task was accomplished. In the example embodied there are seven tasks listed to accomplish the action of John purchasing groceries each week, namely to: plan a weekly menu with budget, to create a shopping list, to travel to a grocery store, to select groceries, to pay for the groceries, to travel home with the groceries, and to store the groceries appropriately.

As illustrated, the tasks table 1304 is a simple table; however, it might also include prompts and static or dynamic templates to guide users through the division of an action into tasks.

Data entered or revised in the Task Planner view 1300 can be saved to the appropriate set of databases 600 through the database management system 418 by activating a Save button 1312. Alternatively, such revisions can be discarded by activating a Cancel button 1314.

Any one of the tasks documented in the tasks table 1304 may be selected for further processing. Upon activation of a +Resource button 1316, a Resource Specifier view 1400 will be opened, as is described more thoroughly with respect to FIG. 14. Alternatively, upon activation of an Estimate button 1318, a Task Estimator view 1600 will be opened, as is described more thoroughly with respect to FIG. 16. In general terms, one would activate the +Resource button 1316 to budget resources to the selected task and would activate the Estimate button 1318 to estimate the total cost of all of the resources budgeted to the selected task. In the embodiment illustrated in FIG. 14, the task “Plan weekly menu within budget” has been selected.

FIG. 14 shows the Resource Specifier view, generally illustrated at 1400, into the Tasks database 612, the Resources database 614, and the Guidelines database 616. The Resource Specifier view 1400 enables a user to specify the nature of any resource required to complete the selected task.

The Resource Specifier view 1400 includes a task field 1402, a resource-type selector 1404, a resource-name field 1406, and resource-specification table 1408, wherein each dimension of the resource-specification is described by a dimension-column 1410, a guidelines-column 1412 and a specification-column 1414.

The task field 1402 identifies the currently selected task for which resources are being budgeted.

The resource-type selector 1404 designates whether the resource being specified is a product or a service. The resource-type may affect what dimensions are specified for a resource and may affect how available resources are matched to resource-requirements. For example, it may be easier to locate non-market service-resources than product-resources, and so cost may be a more critical factor in matching products than services.

The resource-name field 1406 identifies the resource-requirement currently being specified. The resource-requirement and its name can be defined from scratch in the Resource Specifier view 1400 or else can be retrieve from a pre-existing list of resource-requirements from the resources database 614. If a user has been granted sufficient access privileges, he may modify any of the pre-existing resource-requirements. In this embodiment, the resource-requirement being specified is named a “Menu-Planning Helper”.

The resource-specification table 1408 documents the characteristics required of a resource to support the selected task. The dimension-column 1410 identifies the dimensions being specified, those illustrated being “duration”, “frequency”, “cost”, “quality”, “desirable extras”, and “backup availability”.

The guidelines-column 1412 provides advice or constraints for each dimension, those illustrated being “duration less than two hours per week unless there are special circumstances”, “frequency at least bi-weekly”, “cost less than $50 per week unless special circumstances”, “quality includes bondability”, “desirable extras include qualification as a dietician”, and “backup availability is desirable but not required”.

The specification-column 1414 documents the chosen specification for each of the dimensions, as illustrated being “duration is one hour per week”, “frequency is weekly”, “cost is less than $50 per week”, “quality includes bondability or equivalent trustworthiness, for example a close family member”, “desirable extras include qualification as a dietician”, and “backup availability is desirable but not required”.

As illustrated, the resource-specification table 1408 is a simple table; however, it might also include prompts and static or dynamic templates to guide users through the definition of meaningful measurable objectives for the selected goal. The guidelines in the guidelines-column 1412 might either be entered manually or extracted automatically from the guidelines database 616.

Data entered or revised in the Resource Specifier view 1400 can be saved to the appropriate set of databases 600 through the database management system 418 by activating a Save button 1416. Alternatively, such revisions can be discarded by activating a Cancel button 1418.

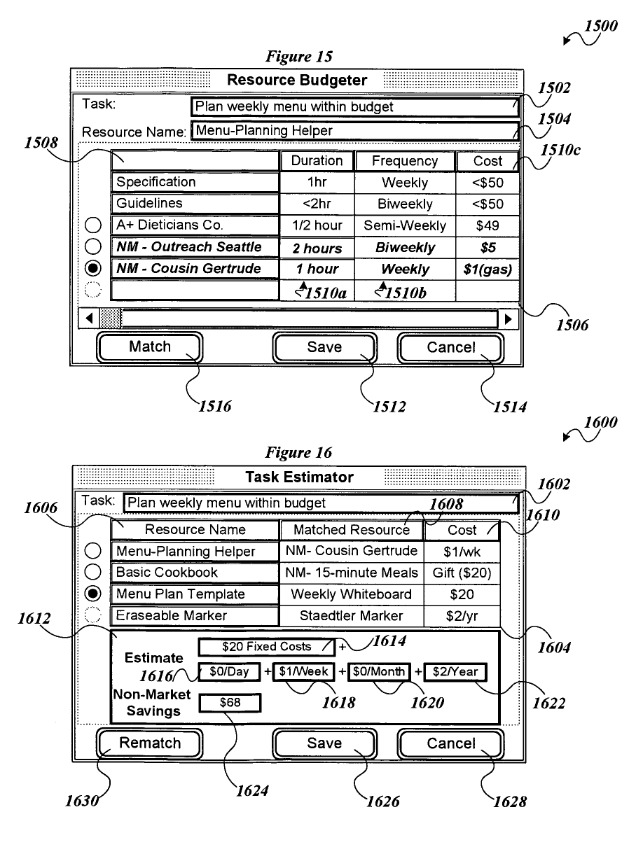

Furthermore, upon activation of a Budget button 1420, a Resource Budgeter view 1500 will be opened, as is described more thoroughly with respect to FIG. 15.

FIG. 15 shows the Resource Budgeter view, generally illustrated at 1500, into the Tasks database 612, and the Resources database 614 The Resource Budgeter view 1500 enables a user to match an available resource to a selected resource-requirement and the task that it supports.

The Resource Budgeter view 1500 includes a task field 1502, a resource-specification field 1504, and an available-resource table 1506, wherein each available resource has its own row that is intersected by a resource-name-column 1508, and a series of dimension-columns 1510, for example a duration-column 1510a, a frequency-column 1510b, and a cost-column 1510c.

The task field 1502 identifies the currently selected task for which resources are being budgeted, as illustrated “Plan weekly menu within budget”.

The resource-specification field 1504 identifies the resource specification that is being matched to available resources, as illustrated “Menu-Planning Helper”.

The available-resource table 1506 details available resources that may satisfy the resource-specification. Such available resource data may be entered manually into the available-resource table 1506 by the user, may be automatically extracted from the resources database 614 or a combination of both. The available resource data may have been received into the resources database 614 from the inventory computer 452 of a supplier or partner, as a matter of general practice or in response to a specific query, for example incorporating the resource-specification. The available-resource table 1506 may highlight one or more available resources as being good prospective matches and may also distinguish non-market from market resources. For convenience of reference, the table may also include a row for the specification and a row for guidelines.

As illustrated, the available-resource table 1506 is a simple table; however, it might also include prompts and static or dynamic templates to guide users through the matching of an available resource to the selected resource-requirement. The guidelines in the guidelines row might either be entered manually or extracted automatically from the guidelines database 616.

Data entered or revised in the Resource Budgeter view 1500 can be saved to the appropriate set of databases 600 through the database management system 418 by activating a Save button 1512. Alternatively, such revisions can be discarded by activating a Cancel button 1514.

Furthermore, upon selecting one of the available resources and activating a Match button 1516, the selected available resource will be matched to the resource-requirement and hence the task being budgeted. As illustrated, non-market resource “Cousin Gertrude” has been matched to visit John weekly for one hour to help him plan his menu and will charge nothing more than $1 for gasoline expenses.

FIG. 16 shows the Task Estimator view, generally illustrated at 1600, into the Tasks database 612 and the Resources database 614. The Task Estimator view 1600 enables a user to estimate the cost of a task as the sum of the costs of its matched resources. As described above, the Task Estimator view 1600 is opened when the Estimate button 1318 in the Task Planner view 1300 is activated.

The Task Estimator view 1600 includes a task field 1602, a matched-resources table 1604 wherein each resource matched to the current task has its own row that is intersected by a specification-name-column 1606, a matched-resource-name-column 1608, and a cost-column 1610. The Task Estimator view 1600 also includes an estimate region 1612.

The task field 1602 identifies the current task being estimated, as illustrated being “Plan weekly menu within budget”.

The matched-resources table 1604 details the available resources that have been budgeted to the task by matching its resource requirements. As illustrated being: “Cousin Gertrude as a Menu Planning Helper charging $1 per week”, “15-minute Meals as a Basic Cookbook which regularly costs $20 but was provided free as a gift”, a “Weekly Whiteboard to provide a Menu Plan Template and costing $20”, and a “Staedtler® Marker as an Erasable Marker for use with the Whiteboard and costing $2”.

The estimate region 1612 sums the costs of the various matched resources, and as illustrated includes a fixed-cost field 1614, a daily-cost field 1616, a weekly-cost field 1618, a monthly-cost field 1620, a yearly-cost field 1622 and a non-market savings field 1624. As illustrated, the estimated cost for the task “Plan weekly menu within budget” is a $20 fixed cost attributable to the Weekly Whiteboard, a $1 weekly cost attributable to Cousin Gertrude's gasoline expenses, a $2 yearly cost attributable to the Staedtler® Marker, and a $68 non-market savings attributed to the gifted 15-minute Meals Basic Cookbook and Cousin Gertrude volunteering her help.

If a user is unhappy with the estimate, he can select one of the rows of the matched-resources table 1604 and activate a Rematch button 1630, which will reopen the Resource Budgeter view 1500 for the resource requirement specification identified in the specification-name-column 1606 of the selected row.

Data entered or revised in the Task Estimator view 1600 can be saved to the appropriate set of databases 600 through the database management system 418 by activating a Save button 1626. Alternatively, such revisions can be discarded by activating a Cancel button 1628.

FIG. 17 shows a Report Builder view, generally illustrated at 1700, that enables a user to configure a report on a project and its plan. As discussed above, the Report Builder view 1700 opens in response to activating the Report button 714 in the Project Select view 700.

The Report Builder view 1700 includes a basic information region 1702, a detailed information region 1704, and a supplementary region 1706.

The basic information region 1702 includes controls for designating whether or not to report the Project ID and contact person, contact details for the contact person, and the salient facts of the project.

The detailed information region 1704 includes controls for designating whether or not to report the goals, objectives, actions, tasks, and resources for a project, and if so, whether to also report the actual performance, performance statistics, and explanatory notes.

The supplementary region 1706 includes controls for designating whether or not to report the audit trail of all additions, revisions, and deletions to the project plan and whether or not to export data from the project for aggregation across multiple projects and plans. It will be appreciated that such aggregation of pertinent data may over time generate custom data sets against which otherwise unique actions could be measured generically.

Designations made in the Report Builder view 1700 can be saved for convenient reuse by activating a Save button 1708 or alternatively discarded by activating a Cancel button 1710. The designated report can be printed to a computer screen by activating a Preview button 1712 or on a printer by activating a Print button 1714.

### (i) DESCRIPTION SUMMARY

Thus, it will be seen from the foregoing embodiments and examples that there has been described a way of planning and more particularly a way of planning to meet the needs of people with special needs living within a community, for example, people working to overcome developmental disabilities.

However, while the invention has been described as having particular application for planning to meet the needs of clients having developmental disabilities, those skilled in the art will recognize that the invention has wider application, for example helping seniors to live reasonably independently in their own homes, foster children to grow into strong adults, juvenile criminals to get their lives back on track, and more generally, assisting clients in a community to meet any kind of goal, for example obtaining qualifications, improving health, losing weight or overcoming an addiction.

While specific embodiments of the invention have been described and illustrated, such embodiments should be considered illustrative of the invention only and not as limiting the invention as construed in accordance with the accompanying claims. It will be understood by those skilled in the art that various changes, modifications and substitutions can be made to the foregoing embodiments without departing from the principle and scope of the invention expressed in the claims made herein.

In particular, it will be appreciated that, because there are a number of stakeholders in many such planning processes, decision-making may be distributed. To reflect this arrangement, some of the illustrated embodiments showed input or constraints provided by stakeholders other than the nominal decision-maker, for example in the form of guidelines provided by government overseers or funding sources. In this regard, those skilled in the art will realize that input, constraints or guidelines could be provided for any of the steps in the planning method, whether or not illustrated by specific embodiments.

What is claimed is:

1. A method of planning an action, comprising:
(a) deciding whether the action is generic or unique; and
(b) either:
(i) planning the action according to a first procedure if the action is generic; or
(ii) planning the action according to a second procedure if the action is unique.

2. A method as claimed in claim 1, wherein the first procedure includes budgeting resources in accordance with historical data.

3. A method as claimed in claim 2, wherein the first procedure includes budgeting resources in accordance with geo-historical data.

4. A method as claimed in claim 3, wherein the first procedure further includes adjusting the budget in accordance with an index.

5. A method as claimed in claim 2, wherein the second procedure includes dividing the action into a list of tasks.

6. A method as claimed in claim 5, further comprising:
(a) for each task:
(i) determining a set of resource requirements for completing the task;
(ii) specifying each resource requirement;
(iii) for each specified resource requirement, identifying at least one satisfactory available resource; and
(iv) respectively matching one identified resource to each specified resource requirement.

7. A method as claimed in claim 6, wherein identifying includes identifying at least one of:
(a) an available market resource; and
(b) an available non-market resource.

8. A method as claimed in claim 7, wherein matching includes emphasizing to a supplier of a non-market resource the importance of that resource to the success of the plan.

9. A method as claimed in claim 6, wherein matching includes matching a resource requirement with the cheapest available resource identified to satisfy it.

10. A method as claimed in claim 6, wherein matching includes matching a resource requirement with the best available resource identified to satisfy it.

11. A method as claimed in claim 6, wherein matching includes matching a resource requirement with the identified available resource that is the best match.

12. A method as claimed in claim 6, wherein matching includes matching a resource requirement with the identified available resource that best matches an objective of the task.

13. A method as claimed in claim 6, wherein specifying includes specifying a property other than cost.

14. A method as claimed in claim 13, wherein specifying includes specifying cost.

15. A method as claimed in claim 13, wherein specifying includes specifying whether a resource requirement is:
(a) a requirement for a service; or
(b) a requirement for a product.

16. A method as claimed in claim 15, wherein specifying includes specifying at least one of:
(a) quantity; and
(b) character.

17. A method as claimed in claim 16, wherein specifying quantity for a requirement for a service includes specifying at least one of:
(a) frequency; and
(b) duration.

18. A method as claimed in claim 15, further including:
(a) for each task:
(i) estimating the total cost of the product resources; and
(ii) estimating the total cost of the service resources.

19. A method as claimed in claim 18, further including estimating the cost of the action as the total cost of the tasks.

20. A method as claimed in claim 19, further comprising:
(a) determining whether the tasks and the resources are sufficient to complete the action according to guidelines; and
(b) if determined insufficient, repeating the method of claim 19 to produce a new list of tasks and a new match of resources.

21. A method as claimed in claim 6, further comprising:
(a) defining a set of goals;
(b) setting measurable objectives for each goal;
(c) scheduling actions to achieve each objective; and
(d) budgeting resources for each action.

22. A method as claimed in claim 21, further comprising investigating initial facts relevant to the planning.

23. A method as claimed in claim 22, further comprising analyzing the initial facts.

24. A method as claimed in claim 21, further comprising comparing the actual results of the planning against planned results, including at least one of:
(a) the goals;
(b) the objectives;
(c) the actions; and
(d) the resource requirements.

25. A method as claimed in claim 24, further comprising explaining deviations between the actual results and the planned results.

26. A method as claimed in claim 25, further comprising:
(a) determining whether the actual results are a complete success, a complete failure, or neither; and
(b) if neither, repeating the method of claim 21.

27. A system for planning an action, comprising:
(a) means for deciding whether the action is generic or unique;
(b) first means for planning the action according to a first procedure if the action is generic; and
(c) second means for planning the action according to a second procedure if the action is unique.

28. A system as claimed in claim 27, wherein the first planning means includes means for budgeting resources in accordance with historical data.

29. A system as claimed in claim 28, wherein the budgeting means is adapted to budget resources in accordance with geo-historical data.

30. A system as claimed in claim 29, wherein the first budgeting means includes means for adjusting the budget in accordance with an index.

31. A system as claimed in claim 27, wherein the second planning means includes means for dividing the action into a list of tasks.

32. A system as claimed in claim 31, further comprising:
(a) means for determining a set of resource requirements for completing each task;
(b) means for specifying each resource requirement;
(c) means for identifying at least one satisfactory available resource, for each specified resource requirement; and
(d) means for respectively matching one identified resource to each specified resource requirement.

33. A system as claimed in claim 32, wherein the identifying means is adapted to identify at least one of:
(a) an available market resource; and
(b) an available non-market resource.

34. A system as claimed in claim 33, wherein the matching means includes means for emphasizing to a supplier of a non-market resource the importance of that resource to the success of the plan.

35. A system as claimed in claim 32, wherein the matching means is adapted to match a resource requirement with the cheapest available resource identified to satisfy it.

36. A system as claimed in claim 32, wherein the matching means is adapted to match a resource requirement with the best available resource identified to satisfy it.

37. A system as claimed in claim 32, wherein the matching means is adapted to match a resource requirement with the identified available resource that is the best match.

38. A system as claimed in claim 32, wherein the matching means is adapted to match a resource requirement with the identified available resource that best matches an objective of the task.

39. A system as claimed in claim 32, wherein the specifying means is adapted to specify a property other than cost.

40. A system as claimed in claim 39, wherein the specifying means is also adapted to specify cost.

41. A system as claimed in claim 39, wherein the specifying means is adapted to specify whether a resource requirement is:
(a) a requirement for a service; or
(b) a requirement for a product.

42. A system as claimed in claim 41, wherein the specifying means is adapted to specify at least one of:
(a) quantity; and
(b) character.

43. A system as claimed in claim 42, wherein specifying quantity for a requirement for a service includes specifying at least one of:
(a) frequency; and
(b) duration.

44. A system as claimed in claim 41, further including means for estimating for each task:
(a) the total cost of the product resources; and
(b) the total cost of the service resources.

45. A system as claimed in claim 44, wherein the estimating means is also adapted to estimate the cost of the action as the total cost of the tasks.

46. A system as claimed in claim 45, further comprising means for determining whether the tasks and the resources are sufficient to complete the action according to guidelines, such that if insufficient, the determining means directs:
(a) the dividing means to divide the action into a new list of tasks;
(b) the determining means to determine a new set of resource requirements for completing each new task;
(c) the specifying means to specify each new resource requirement; and
(d) the matching means to match one identified resource to each newly specified resource requirement.

47. A system as claimed in claim 32, further comprising:
(a) means for defining a set of goals;
(b) means for setting measurable objectives for each goal;
(c) means for scheduling actions to achieve each objective; and
(d) second means for budgeting resources for each action.

48. A system as claimed in claim 47, further comprising means for investigating initial facts relevant to the planning.

49. A system as claimed in claim 48, further comprising means for analyzing the initial facts.

50. A system as claimed in claim 47, further comprising means for comparing the actual results of the planning against planned results, including at least one of:
(a) the goals;
(b) the objectives;
(c) the actions; and
(d) the resource requirements.

51. A system as claimed in claim 50, further comprising means for explaining deviations between the actual results and the planned results.

52. A system as claimed in claim 51, further comprising:
(a) means for indicating whether the actual results compared against the planned results are one of:
(i) a complete success;
(ii) a complete failure; and
(iii) neither; and
(b) means for stopping the system in response to an indication that the actual results are one of a complete success and a complete failure.

53. A computer-readable medium having computer-executable instructions for performing a method of planning an action, comprising:
(a) deciding whether the action is generic or unique; and
(b) either:
(i) planning the action according to a first procedure if the action is generic; or
(ii) planning the action according to a second procedure if the action is unique.

54. A computer-readable medium as claimed in claim 53, wherein the first procedure includes budgeting resources in accordance with historical data.

55. A computer-readable medium as claimed in claim 54, wherein the first procedure includes budgeting resources in accordance with geo-historical data.

56. A computer-readable medium as claimed in claim 55, wherein the first procedure further includes adjusting the budget in accordance with an index.

57. A computer-readable medium as claimed in claim 54, wherein the second procedure includes dividing the action into a list of tasks.

58. A computer-readable medium as claimed in claim 57, further having computer-executable instructions for, for each task:
(a) determining a set of resource requirements for completing the task;
(b) specifying each resource requirement;
(c) for each specified resource requirement, identifying at least one satisfactory available resource; and
(d) respectively matching one identified resource to each specified resource requirement.

59. A computer-readable medium as claimed in claim 58, wherein identifying includes identifying at least one of:
(a) an available market resource; and
(b) an available non-market resource.

60. A computer-readable medium as claimed in claim 59, wherein matching includes emphasizing to a supplier of a non-market resource the importance of that resource to the success of the plan.

61. A computer-readable medium as claimed in claim 58, wherein matching includes matching a resource requirement with the cheapest available resource identified to satisfy it.

62. A computer-readable medium as claimed in claim 58, wherein matching includes matching a resource requirement with the best available resource identified to satisfy it.

63. A computer-readable medium as claimed in claim 58, wherein matching includes matching a resource requirement with the identified available resource that is the best match.

64. A computer-readable medium as claimed in claim 58, wherein matching includes matching a resource requirement with the identified available resource that best matches an objective of the task.

65. A computer-readable medium as claimed in claim 58, wherein specifying includes specifying a property other than cost.

66. A computer-readable medium as claimed in claim 65, wherein specifying includes specifying cost.

67. A computer-readable medium as claimed in claim 65, wherein specifying includes specifying whether a resource requirement is:
(a) a requirement for a service; or
(b) a requirement for a product.

68. A computer-readable medium as claimed in claim 67, wherein specifying includes specifying at least one of:
(a) quantity; and
(b) character.

69. A computer-readable medium as claimed in claim 68, wherein specifying quantity for a requirement for a service includes specifying at least one of:
(a) frequency; and
(b) duration.

70. A computer-readable medium as claimed in claim 67, further having computer-executable instructions for, for each task:
(a) estimating the total cost of the product resources; and
(b) estimating the total cost of the service resources.

71. A computer-readable medium as claimed in claim 70, further having computer-executable instructions for estimating the cost of the action as the total cost of the tasks.

72. A computer-readable medium as claimed in claim 71, further having computer-executable instructions for:
(a) determining whether the tasks and the resources are sufficient to complete the action according to guidelines; and
(b) if determined insufficient, repeating the method of claim 71 to produce a new list of tasks and a new match of resources.

73. A computer-readable medium as claimed in claim 58, further having computer-executable instructions for:
(a) defining a set of goals;
(b) setting measurable objectives for each goal;
(c) scheduling actions to achieve each objective; and
(d) budgeting resources for each action.

74. A computer-readable medium as claimed in claim 73, further having computer-executable instructions for investigating initial facts relevant to the planning.

75. A computer-readable medium as claimed in claim 74, further having computer-executable instructions for analyzing the initial facts.

76. A computer-readable medium as claimed in claim 73, further having computer-executable instructions for comparing the actual results of the planning against planned results, including at least one of:
(a) the goals;
(b) the objectives;
(c) the actions; and
(d) the resource requirements.

77. A computer-readable medium as claimed in claim 76, further having computer-executable instructions for explaining deviations between the actual results and the planned results.

78. A computer-readable medium as claimed in claim 77, further having computer-executable instructions for:
(a) determining whether the actual results are a complete success, a complete failure, or neither; and
(b) if neither, repeating the method of claim 73.

79. A method of planning, comprising providing historical data for budgeting resources for an action that has been determined to be generic as opposed to unique.

80. A method as claimed in claim 79, wherein providing historical data includes providing geo-historical data.

81. A method as claimed in claim 80, further comprising providing an index.

82. A system for planning, comprising means for providing historical data for budgeting resources for an action that has been determined to be generic as opposed to unique.

83. A system as claimed in claim 82, wherein the means for providing historical data includes means for providing geo-historical data.

84. A system as claimed in claim 83, further comprising means for providing an index.

85. A computer-readable medium having computer-executable instructions for performing a method of planning, comprising providing historical data for budgeting resources for an action that has been determined to be generic as opposed to unique.

86. A computer-readable medium as claimed in claim 85, wherein providing historical data includes providing geo-historical data.

87. A computer-readable medium as claimed in claim 86, further having computer-executable instructions for providing an index.

88. A method of planning, comprising determining a set of resource requirements for completing a task in the performance of an action that has been decided to be unique as opposed to generic.

89. A method as claimed in claim 88, further comprising specifying each resource requirement.

90. A method as claimed in claim 89, further comprising, for each specified resource requirement, identifying at least one satisfactory available resource.

91. A method as claimed in claim 90, further comprising respectively matching one identified resource to each specified resource requirement.

92. A method as claimed in claim 89, wherein specifying includes specifying a property other than cost.

93. A method as claimed in claim 92, wherein specifying includes specifying cost.

94. A method as claimed in claim 93, wherein specifying includes specifying whether a resource requirement is:
(a) a requirement for a service; or
(b) a requirement for a product.

95. A method as claimed in claim 94, wherein specifying includes specifying at least one of:
(a) quantity; and
(b) character.

96. A method as claimed in claim 95, wherein specifying quantity for a requirement for a service includes specifying at least one of:
(a) frequency; and
(b) duration.

97. A method as claimed in claim 88, further comprising defining a set of goals.

98. A method as claimed in claim 97, further comprising setting measurable objectives for each goal.

99. A method as claimed in claim 98, further comprising scheduling actions to achieve each objective.

100. A method as claimed in claim 99, further comprising budgeting resources for each action.

101. A method as claimed in claim 100, further comprising investigating initial facts relevant to the planning.

102. A method as claimed in claim 101, further comprising comparing the actual results of the planning against planned results, including at least one of:
(a) the goals;
(b) the objectives;
(c) the actions; and
(d) the resource requirements.

103. A method as claimed in claim 102, further comprising explaining deviations between the actual results and the planned results.

104. A method as claimed in claim 103, further comprising:
(a) determining whether the actual results are a complete success, a complete failure, or neither; and
(b) if neither, repeating the method of claim 98.

105. A system for planning, comprising means for determining a set of resource requirements for completing a task in the performance of an action that has been decided to be unique as opposed to generic.

106. A system as claimed in claim 105, further comprising means for specifying each resource requirement.

107. A system as claimed in claim 106, further comprising, means for identifying at least one satisfactory available resource for each specified resource requirement.

108. A system as claimed in claim 107, further comprising means for respectively matching one identified resource to each specified resource requirement.

109. A system as claimed in claim 106, wherein specifying includes specifying a property other than cost.

110. A system as claimed in claim 109, wherein specifying includes specifying cost.

111. A system as claimed in claim 110, wherein specifying includes specifying whether a resource requirement is:
(a) a requirement for a service; or
(b) a requirement for a product.

112. A system as claimed in claim 111, wherein specifying includes specifying at least one of:
(a) quantity; and
(b) character.

113. A system as claimed in claim 112, wherein specifying quantity for a requirement for a service includes specifying at least one of:
(a) frequency; and
(b) duration.

114. A system as claimed in claim 105, further comprising means for defining a set of goals.

115. A system as claimed in claim 114, further comprising means for setting measurable objectives for each goal.

116. A system as claimed in claim 115, further comprising means for scheduling actions to achieve each objective.

117. A system as claimed in claim 116, further comprising means for budgeting resources for each action.

118. A system as claimed in claim 117, further comprising means for investigating initial facts relevant to the planning.

119. A system as claimed in claim 118, further comprising means for comparing the actual results of the planning against planned results, including at least one of:
(a) the goals;
(b) the objectives;
(c) the actions; and
(d) the resource requirements.

120. A system as claimed in claim 119, further comprising means for explaining deviations between the actual results and the planned results.

121. A system as claimed in claim 120, further comprising:
(a) means for indicating whether the actual results compared against the planned results are one of:
(i) a complete success,
(ii) a complete failure; and
(iii) neither; and,
(b) means for stopping the system in response to an indication that the actual results are one of a complete success and a complete failure.

122. A computer-readable medium having computer-executable instructions for performing a method of planning, comprising determining a set of resource requirements for completing a task in the performance of an action that has been decided to be unique as opposed to generic.

123. A computer-readable medium as claimed in claim 122, further having computer-executable instructions for specifying each resource requirement.

124. A computer-readable medium as claimed in claim 123, further having computer-executable instructions for identifying at least one satisfactory available resource for each specified resource requirement.

125. A computer-readable medium as claimed in claim 124, further having computer-executable instructions for respectively matching one identified resource to each specified resource requirement.

126. A computer-readable medium as claimed in claim 123, wherein specifying includes specifying a property other than cost.

127. A computer-readable medium as claimed in claim 126, wherein specifying includes specifying cost.

128. A computer-readable medium as claimed in claim 127, wherein specifying includes specifying whether a resource requirement is:
(a) a requirement for a service; or
(b) a requirement for a product.

129. A computer-readable medium as claimed in claim 128, wherein specifying includes specifying at least one of:
(a) quantity; and
(b) character.

130. A computer-readable medium as claimed in claim 129, wherein specifying quantity for a requirement for a service includes specifying at least one of:
(a) frequency; and
(b) duration.

131. A computer-readable medium as claimed in claim 122, further having computer-executable instructions for defining a set of goals.

132. A computer-readable medium as claimed in claim 131, further having computer-executable instructions for setting measurable objectives for each goal.

133. A computer-readable medium as claimed in claim 132, further having computer-executable instructions for scheduling actions to achieve each objective.

134. A computer-readable medium as claimed in claim 133, further having computer-executable instructions for budgeting resources for each action.

135. A computer-readable medium as claimed in claim 134, further having computer-executable instructions for investigating initial facts relevant to the planning.

136. A computer-readable medium as claimed in claim 135, further having computer-executable instructions for comparing the actual results of the planning against planned results, including at least one of:
(a) the goals;
(b) the objectives;
(c) the actions; and
(d) the resource requirements.

137. A computer-readable medium as claimed in claim 136, further having computer-executable instructions for explaining deviations between the actual results and the planned results.

138. A computer-readable medium as claimed in claim 137, further having computer-executable instructions for:
(a) determining whether the actual results are a complete success, a complete failure, or neither; and
(b) if neither, repeating the computer-readable medium of claim 132.

139. A method of planning, comprising providing guidelines for determining a set of resource requirements for completing a task in the performance of an action that has been decided to be unique as opposed to generic.

140. A method as claimed in claim 139, further comprising providing guidelines for specifying a resource requirement.

141. A method as claimed in claim 140, wherein specifying includes specifying a property other than cost.

142. A method as claimed in claim 141, wherein specifying includes specifying cost.

143. A method as claimed in claim 142, wherein specifying includes specifying whether a resource requirement is:
(a) a requirement for a service; or
(b) a requirement for a product.

144. A method as claimed in claim 143, wherein specifying includes specifying at least one of:
(a) quantity; and
(b) character.

145. A method as claimed in claim 144, wherein specifying quantity for a requirement for a service includes specifying at least one of:
(a) frequency; and
(b) duration.

146. A method as claimed in claim 139, further comprising providing guidelines for defining a set of goals.

147. A method as claimed in claim 146, further comprising providing guidelines for setting measurable objectives for at least one of the goals.

148. A method as claimed in claim 147, further comprising providing guidelines for scheduling actions to achieve at least one of the objectives.

149. A method as claimed in claim 148, further comprising providing guidelines for budgeting resources for at least one of the actions.

150. A method as claimed in claim 149, further comprising providing guidelines for investigating initial facts relevant to the planning.

151. A method as claimed in claim 150, further comprising providing guidelines for comparing the actual results of the planning against planned results, including at least one of:
(a) the goals;
(b) the objectives;
(c) the actions; and
(d) the resource requirements.

152. A method as claimed in claim 151, further comprising providing guidelines for explaining deviations between the actual results and the planned results.

153. A method as claimed in claim 152, further comprising:
(a) providing guidelines for determining whether the actual results are a complete success, a complete failure, or neither; and
(b) if neither, repeating the method of claim 147.

154. A system for planning, comprising means for providing guidelines for determining a set of resource requirements for completing a task in the performance of an action that has been decided to be unique as opposed to generic.

155. A system as claimed in claim 154, further comprising means for providing guidelines for specifying a resource requirement.

156. A system as claimed in claim 155, wherein specifying includes specifying a property other than cost.

157. A system as claimed in claim 156, wherein specifying includes specifying cost.

158. A system as claimed in claim 157, wherein specifying includes specifying whether a resource requirement is:
(a) a requirement for a service; or
(b) a requirement for a product.

159. A system as claimed in claim 158, wherein specifying includes specifying at least one of:
(a) quantity; and
(b) character.

160. A system as claimed in claim 159, wherein specifying quantity for a requirement for a service includes specifying at least one of:
(a) frequency; and
(b) duration.

161. A system as claimed in claim 154, further comprising means for providing guidelines for defining a set of goals.

162. A system as claimed in claim 161, further comprising means for providing guidelines for setting measurable objectives for at least one of the goals.

163. A system as claimed in claim 162, further comprising means for providing guidelines for scheduling actions to achieve at least one of the objectives.

164. A system as claimed in claim 163, further comprising means for providing guidelines for budgeting resources for at least one of the actions.

165. A system as claimed in claim 164, further comprising means for providing guidelines for investigating initial facts relevant to the planning.

166. A system as claimed in claim 165, further comprising means for providing guidelines for comparing the actual results of the planning against planned results, including at least one of:
(a) the goals;
(b) the objectives;
(c) the actions; and
(d) the resource requirements.

167. A system as claimed in claim 166, further comprising means for providing guidelines for explaining deviations between the actual results and the planned results.

168. A system as claimed in claim 167, further comprising:
(a) means for providing guidelines indicating whether the actual results compared against the planned results are one of:
(i) a complete success,
(ii) a complete failure; and
(iii) neither; and,
(b) means for stopping the system in response to an indication that the actual results are one of a complete success and a complete failure.

169. A computer-readable medium having computer-executable instructions for performing a method of planning, comprising providing guidelines for determining a set of resource requirements for completing a task in the performance of an action that has been decided to be unique as opposed to generic.

170. A computer-readable medium as claimed in claim 169, further having computer-executable instructions for providing guidelines for specifying a resource requirement.

171. A computer-readable medium as claimed in claim 170, wherein specifying includes specifying a property other than cost.

172. A computer-readable medium as claimed in claim 171, wherein specifying includes specifying cost.

173. A computer-readable medium as claimed in claim 172, wherein specifying includes specifying whether a resource requirement is:
(a) a requirement for a service; or
(b) a requirement for a product.

174. A computer-readable medium as claimed in claim 173, wherein specifying includes specifying at least one of:
(a) quantity; and
(b) character.

175. A computer-readable medium as claimed in claim 174, wherein specifying quantity for a requirement for a service includes specifying at least one of:
(a) frequency; and
(b) duration.

176. A computer-readable medium as claimed in claim 169, further having computer-executable instructions for providing guidelines for defining a set of goals.

177. A computer-readable medium as claimed in claim 176, further having computer-executable instructions for providing guidelines for setting measurable objectives for at least one of the goals.

178. A computer-readable medium as claimed in claim 177, further having computer-executable instructions for providing guidelines for scheduling actions to achieve at least one of the objectives.

179. A computer-readable medium as claimed in claim 178, further having computer-executable instructions for providing guidelines for budgeting resources for at least one of the actions.

180. A computer-readable medium as claimed in claim 179, further having computer-executable instructions for providing guidelines for investigating initial facts relevant to the planning.

181. A computer-readable medium as claimed in claim 180, further having computer-executable instructions for providing guidelines for comparing the actual results of the planning against planned results, including at least one of:
(a) the goals;
(b) the objectives;
(c) the actions; and
(d) the resource requirements.

182. A computer-readable medium as claimed in claim 181, further having computer-executable instructions for providing guidelines for explaining deviations between the actual results and the planned results.

183. A computer-readable medium as claimed in claim 182, further having computer-executable instructions for:
(a) providing guidelines for determining whether the actual results are a complete success, a complete failure, or neither; and
(b) if neither, repeating the method of claim 177.

184. A method of planning comprising offering an available resource for matching to resource requirements specified for tasks in the performance of actions that have been decided to be unique as opposed to generic.

185. A method as claimed in claim 184, wherein offering includes offering a plurality of available resources.

186. A method as claimed in claim 185, wherein offering includes advertising a resource on behalf of its owner.

187. A method as claimed in claim 185, wherein offering includes offering a resource on behalf of its owner.

188. A system for planning comprising means for offering an available resource for matching to resource requirements specified for tasks in the performance of actions that have been decided to be unique as opposed to generic.

189. A system as claimed in claim 188, wherein offering includes offering a plurality of available resources.

190. A system as claimed in claim 189, wherein offering includes advertising a resource on behalf of its owner.

191. A system as claimed in claim 189, wherein offering includes offering a resource on behalf of its owner.

192. A computer-readable medium having computer-executable instructions for performing a method of planning comprising offering an available resource for matching to resource requirements specified for tasks in the performance of actions that have been decided to be unique as opposed to generic.

193. A computer-readable medium as claimed in claim 192, wherein offering includes offering a plurality of available resources.

194. A computer-readable medium as claimed in claim 193, wherein offering includes advertising a resource on behalf of its owner.

195. A computer-readable medium as claimed in claim 193, wherein offering includes offering a resource on behalf of its owner.

196. A method of planning, comprising defining a set of goals to be accomplished by the execution of a set of actions, each such action planned according to a first procedure if it is generic and planned according to a second procedure if it is unique.

197. The method of claim 196, wherein the first procedure includes at least one of:
a) budgeting resources in accordance with historical data;
b) budgeting resources in accordance with geo-historical data; and
c) budgeting resources in accordance with an index.

198. The method of claim 197, wherein the second procedure includes:
(a) dividing the respective action into a list of tasks; and
(b) for each task:
(i) determining a set of resource requirements for completing the task;
(ii) specifying each resource requirement;
(iii) for each specified resource requirement, identifying at least one satisfactory available resource; and
(iv) respectively matching one identified resource to each specified resource requirement.

199. A method as claimed in claim 198, further comprising setting measurable objectives for each goal.

200. A method as claimed in claim 199, further comprising scheduling actions to achieve each objective.

201. A method as claimed in claim 200, further comprising budgeting resources for each action.

202. A system for planning, comprising means for defining a set of goals to be accomplished by the execution of a set of actions, each such action planned according to a first procedure if it is generic and planned according to a second procedure if it is unique.

203. The system of claim 202, wherein the first procedure includes at least one of:
a) budgeting resources in accordance with historical data;
b) budgeting resources in accordance with geo-historical data; and
c) budgeting resources in accordance with an index.

204. The system of claim 203, wherein the second procedure includes:
(a) dividing the respective action into a list of tasks; and
(b) for each task:
(i) determining a set of resource requirements for completing the task;
(ii) specifying each resource requirement;
(iii) for each specified resource requirement, identifying at least one satisfactory available resource; and
(iv) respectively matching one identified resource to each specified resource requirement.

205. A system as claimed in claim 204, further comprising means for setting measurable objectives for each goal.

206. A system as claimed in claim 205, further comprising means for scheduling actions to achieve each objective.

207. A system as claimed in claim 206, further comprising means for budgeting resources for each action.

208. A computer-readable medium having computer-executable instructions for performing a method of planning, comprising defining a set of goals to be accomplished by the execution of a set of actions, each such action planned according to a first procedure if it is generic and planned according to a second procedure if it is unique.

209. The computer-readable medium of claim 208, wherein the first procedure includes at least one of:
a) budgeting resources in accordance with historical data;
b) budgeting resources in accordance with geo-historical data; and
c) budgeting resources in accordance with an index.

210. The computer-readable medium of claim 209, wherein the second procedure includes:
(a) dividing the respective action into a list of tasks; and
(b) for each task:
(i) determining a set of resource requirements for completing the task;
(ii) specifying each resource requirement;
(iii) for each specified resource requirement, identifying at least one satisfactory available resource; and
(iv) respectively matching one identified resource to each specified resource requirement.

211. A computer-readable medium as claimed in claim 210, further having computer-executable instructions for setting measurable objectives for each goal.

212. A computer-readable medium as claimed in claim 211, further having computer-executable instructions for scheduling actions to achieve each objective.

213. A computer-readable medium as claimed in claim 212, further having computer-executable instructions for budgeting resources for each action.

214. An application program interface embodied on one or more computer readable media, comprising a first group of services related to planning an action according to first functions if the action is generic and planning the action according to a second functions if the action is unique.

215. An application program interface as claimed in claim 214, wherein the first functions enable budgeting resources in accordance with historical data.

216. An application program interface as claimed in claim 215, wherein the first functions enable budgeting resources in accordance with geo-historical data.

217. An application program interface as claimed in claim 216, wherein the first functions enable adjusting the budget in accordance with an index.

218. An application program interface as claimed in claim 215, wherein the second functions enable dividing the action into a list of tasks.

219. An application program interface as claimed in claim 218, wherein the second functions enable:
(a) for each task:
(i) determining a set of resource requirements for completing the task;
(ii) specifying each resource requirement;
(iii) for each specified resource requirement, identifying at least one satisfactory available resource; and
(iv) respectively matching one identified resource to each specified resource requirement.

220. An application program interface as claimed in claim 219, wherein identifying includes identifying at least one of:
(a) an available market resource; and
(b) an available non-market resource.

221. An application program interface as claimed in claim 220, wherein matching includes emphasizing to a supplier of a non-market resource the importance of that resource to the success of the plan.

222. An application program interface as claimed in claim 219, wherein matching includes matching a resource requirement with the cheapest available resource identified to satisfy it.

223. An application program interface as claimed in claim 219, wherein matching includes matching a resource requirement with the best available resource identified to satisfy it.

224. An application program interface as claimed in claim 219, wherein matching includes matching a resource requirement with the identified available resource that is the best match.

225. An application program interface as claimed in claim 219, wherein matching includes matching a resource requirement with the identified available resource that best matches an objective of the task.

226. An application program interface as claimed in claim 219, wherein specifying includes specifying a property other than cost.

227. An application program interface as claimed in claim 226, wherein specifying includes specifying cost.

228. An application program interface as claimed in claim 226, wherein specifying includes specifying whether a resource requirement is:
(a) a requirement for a service; or
(b) a requirement for a product.

229. An application program interface as claimed in claim 228, wherein specifying includes specifying at least one of:
(a) quantity; and
(b) character.

230. An application program interface as claimed in claim 229, wherein specifying quantity for a requirement for a service includes specifying at least one of:
(a) frequency; and
(b) duration.

231. An application program interface as claimed in claim 228, wherein the second functions further enable:
(a) for each task:
(i) estimating the total cost of the product resources; and
(ii) estimating the total cost of the service resources.

232. An application program interface as claimed in claim 231, wherein the second functions further enable estimating the cost of the action as the total cost of the tasks.

233. An application program interface as claimed in claim 232, wherein the second functions further enable:
(a) determining whether the tasks and the resources are sufficient to complete the action according to guidelines; and
(b) if determined insufficient, repeating the method of claim 232 to produce a new list of tasks and a new match of resources.

234. An application program interface as claimed in claim 219, further comprising a second group of services related to planning a project.

235. An application program interface as claimed in claim 234, wherein the second group of services comprise first functions enabling defining a set of goals.

236. An application program interface as claimed in claim 235, wherein the second group of services comprise second functions enabling setting measurable objectives for each goal.

237. An application program interface as claimed in claim 236, wherein the second group of services comprise third functions enabling scheduling actions to achieve each objective.

238. An application program interface as claimed in claim 237, wherein the second group of services comprise fourth functions enabling budgeting resources for each action.

239. An application program interface as claimed in claim 238, wherein the second group of services comprise fifth functions enabling investigating initial facts relevant to the planning.

240. An application program interface as claimed in claim 239, wherein the second group of services comprise sixth functions enabling analyzing the initial facts.

241. An application program interface as claimed in claim 238, wherein the second group of services comprise seventh functions enabling comparing the actual results of the planning against planned results, including at least one of:
(a) the goals;
(b) the objectives;
(c) the actions; and
(d) the resource requirements.

242. An application program interface as claimed in claim 241, wherein the second group of services comprise eighth functions enabling explaining deviations between the actual results and the planned results.

243. An application program interface as claimed in claim 242, wherein the second group of services comprise ninth functions enabling:
(a) determining whether the actual results are a complete success, a complete failure, or neither; and
(b) if neither, invoking the application program interface of claim 238.

244. In a computer system having a graphical user interface including a display and a selection device, a method of providing information about a planned action and selecting a method of planning the action, the method comprising:
(a) presenting on the display a description of the planned action;
(b) presenting on the display a selectable first control associated with a computer-implemented method for planning a generic action by budgeting resources in accordance with historical data;
(c) presenting on the display a selectable second control associated with a computer-implemented method for planning a unique action by dividing the action into a list of tasks;
(d) receiving a selection signal indicative of the selection device pointing at the selected control; and
(e) in response to the selection signal, invoking the method for planning associated with the selected control.

245. A method as claimed in claim 244, further comprising presenting on the display an objective of the action.

246. A method as claimed in claim 244, further comprising presenting on the display guidelines for the action.

247. A method as claimed in claim 244, further comprising presenting on the display actual results of the action.

248. In a computer system having a graphical user interface including a display and a selection device, a method of estimating the cost of a planned action, the method comprising:
(a) presenting on the display a description of the planned action;
(b) presenting on the display a set of generic actions, of which one may be selected with the selection device as being the most equivalent to the planned action; and
(c) presenting on the display the historical cost of the equivalent generic action.

249. A method as claimed in claim 248, further comprising presenting on the display a set of date-range filters, of which one or more may be selected with the selection device to refine the historical cost of the equivalent generic action.

250. A method as claimed in claim 249, further comprising presenting on the display a set of geographic filters, of which one or more may be selected with the selection device to refine the historical cost of the equivalent generic action.

251. A method as claimed in claim 250, further comprising presenting on the display a set of index adjustments, of which one or more may be selected with the selection device to refine the historical cost of the equivalent generic action.

252. In a computer system having a graphical user interface including a display and a selection device, a method of matching an available resource to a resource requirement for a planned task, the method comprising:
(a) presenting on the display a description of the resource required;
(b) presenting on the display a specification of the resource required; and
(c) presenting on the display a set of available resources, of which one may be selected with the selection device to match the resource requirement.

253. A method as claimed in claim 252, further comprising presenting on the display the specifications for each of the available resources.

254. A method as claimed in claim 253, further comprising presenting on the display guidelines for matching an available resource to the resource requirement.

255. A method as claimed in claim 254, wherein at least one of the specification of the resource required, the specifications for each of the available resources, and the guidelines is presented in tabular format.

256. A method as claimed in claim 255, further comprising presenting on the display a description of the planned task.

257. In a computer system having a graphical user interface including a display and a selection device, a method of estimating the aggregate cost of resources matched to a planned task, the method comprising:
(a) presenting on the display a list of the matched resources, including the respective cost per time interval for each resource; and
(b) presenting on the display the estimated aggregate cost as a sum of fixed plus variable costs.

258. A method as claimed in claim 257, including presenting the variable costs on the display as a sum of daily, weekly, monthly and yearly costs.

259. A method as claimed in claim 257, further comprising presenting on the display a cost savings calculated as the difference between the aggregate of the market values of each of the matched resources and the aggregate actual cost of the matched resources.

260. A method as claimed in claim 257, further comprising:
(a) selecting one of the listed matched resources with the selection device;
(b) presenting on the display a selectable control associated with a computer-implemented method for rematching available resources to the task;
(c) receiving a selection signal indicative of the selection device pointing at the selectable control; and
(d) in response to the selection signal, invoking the method for rematching available resources to the task to replace the selected resource.

261. A computer-readable medium having stored thereon a data structure comprising:
a first field containing data representing a description of an action;
a second field containing data designating whether the action is a generic action or a unique action;
a third field containing data representing an estimated cost of the action; and
if the action is designated as being a unique action, a fourth field containing data representing a list of tasks that the action has been divided into.

262. A computer-readable medium as claimed in claim 261, wherein, if the action is designated as being a unique action, the data structure further comprises a fifth field containing data representing lists of resource requirements respectively associated with each task.

263. A computer-readable medium as claimed in claim 262, wherein, if the action is designated as being a unique action, the data structure further comprises a sixth field containing data representing lists of guidelines respectively associated with at least one of:
(a) a resource requirement;
(b) a task; and
(c) the action.

264. A computer-readable medium as claimed in claim 262, wherein, if the action is designated as being a unique action, the data structure further comprises a seventh field containing data representing lists of available resources respectively matched with resource requirement.

265. Premises for planning a project with a client, comprising:
(a) consulting facilities for consulting with the client to define goals of the project, objectives in support of the goals, and actions for achieving the objectives;
(b) research facilities for deciding whether each action is either generic or unique and for budgeting resources to each generic action in accordance with historical data; and
(c) planning facilities for planning tasks for implementing unique actions, specifying resource requirements for each task, and matching available resources to each resource requirement.

266. Premises as claimed in claim 265, wherein the consulting facilities and the planning facilities are the same.

267. Premises as claimed in claim 265, wherein the research facilities include access to a database of historical data.

268. Premises as claimed in claim 265, wherein the planning facilities include means for communicating with stakeholders in the plan.

269. Premises as claimed in claim 268, wherein the stakeholders include at least one of:
(a) the client;
(b) supporters for the client;
(c) a government entity overseeing the plan;
(d) a funding entity contributing to the funding of the plan;
(e) suppliers of available resources; and
(f) a remotely-located planner.

270. Premises as claimed in claim 269, wherein the means for communicating includes at least one of:
(a) a meeting table;
(b) a telephone;
(c) a videophone; and
(d) a computing device connected to a communication network.

271. Premises as claimed in claim 265, further comprising lounge facilities to enable a person to absent himself from the consulting or the planning.

272. Premises as claimed in claim 265, further comprising reception facilities for inviting prospective clients to learn about the planning.

273. Premises as claimed in claim 265, wherein the facilities are sized to fit conveniently within the community being served.
